(19) United States
(12) Patent Application Publication
(10) Pub. No.: US 2015/0247729 A1
(43) Pub. Date: Sep. 3, 2015

(54) SYSTEM AND METHOD FOR DEVICE BEARING ESTIMATION

(71) Applicants: Deborah Meduna, San Francisco, CA (US); Benjamin E. Joseph, Oakland, CA (US)

(72) Inventors: Deborah Meduna, San Francisco, CA (US); Benjamin E. Joseph, Oakland, CA (US)

(21) Appl. No.: 14/239,102

(22) PCT Filed: Sep. 4, 2013
(86) PCT No.: PCT/US2013/058055

§ 371 Date: Feb. 14, 2014

Related U.S. Application Data
(60) Provisional application No. 61/696,739, filed on Sep. 4, 2012.
(60) Provisional application No. 61/873,318, filed on Sep. 3, 2013.

(51) Int. Cl. G01C 21/20; G01P 13/02

(52) U.S. Cl. CPC G01C 21/20; G01P 13/02

(57) ABSTRACT

A processing apparatus determines an estimated direction of motion of an entity physically associated with a device having a plurality of sensors for generating an estimate of a navigational state of the device. The estimated direction of motion is based at least in part on a device-to-frame orientation corresponding to an orientation of the device relative to a predefined inertial frame of reference, and an estimated device-to-entity orientation corresponding to an orientation of the device relative to a direction of motion of the entity. In response to detecting a change in the device-to-frame orientation, the processing apparatus divides the change in the device-to-frame orientation between a change in the estimated direction of motion of the entity and a change in the estimated device-to-entity orientation, and updates the estimated direction of motion of the entity based on the division of the change in the device-to-frame orientation.

### TECHNICAL FIELD

The disclosed embodiments relate generally to determining a direction of motion of an entity associated with a navigation sensing device.

### BACKGROUND

A navigation sensing device detects changes in navigational state of the device using one or more sensors. In some situations sensor measurements from multiple sensors are combined to determine a navigational state of the sensing device. The navigational state of the device can be used for many different purposes, including controlling a user interface (e.g., moving a mouse cursor) and tracking movements of the navigation sensing device over time. In a number of applications, it is desirable to obtain a bearing estimation (e.g., the walking direction of a person) of a user of a mobile device.

### SUMMARY

However, many methodologies for bearing estimation are limited to use cases where the device is strapped down to the user or to an apparatus having a fixed orientation relative to the user, rendering these methodologies impractical in typical hand-held, mobile device scenarios in which device orientation relative to entity direction of motion typically varies over time. This is particularly true for indoor positioning and bearing estimation, regardless of the positioning and/or orientation sensors used.

Thus, given the limitations of existing techniques, a method for estimating device bearing, or bearing of an entity physically associated with the device, in applications involving arbitrarily held mobile devices is desirable.

Some embodiments provide a method for estimating device bearing at a processing apparatus having one or more processors and memory storing one or more programs that, when executed by the one or more processors, cause the respective processing apparatus to perform the method. The method includes determining an estimated direction of motion of an entity physically associated with a device. The device has a plurality of sensors used to generate an estimate of a navigational state of the device. The estimated direction of motion of the entity is based at least in part on: a device-to-frame orientation, where the device-to-frame orientation corresponds to an orientation of the device relative to a predefined inertial frame of reference, and an estimated device-to-entity orientation, where the device-to-entity orientation corresponds to an orientation of the device relative to a direction of motion of the entity. The method further includes detecting a change in the device-to-frame orientation. In response to detecting the change in the device-to-frame orientation, the method also includes: dividing the change in the device-to-frame orientation between a change in the estimated direction of motion of the entity and a change in the estimated device-to-entity orientation, and updating the estimated direction of motion of the entity based on the division of the change in the device-to-frame orientation between the change in the estimated direction of motion of the entity and the change in the estimated device-to-entity orientation.

In some implementations, the entity is a user of the device. In some implementations, the method includes, prior to determining the estimated direction of motion of the entity, determining an initial estimate of the device-to-frame orientation. In some implementations, the method includes, prior to determining the estimated direction of motion of the entity, determining an initial estimate of the device-to-entity orientation. Further, in some implementations, the initial estimate of the device-to-entity orientation is determined based on a change in sensor measurements over time for one or more of the plurality of sensors, and the sensor measurements used to determine the initial estimate of the device-to-entity orientation include one or more sensor measurements corresponding to a point in time when the device is at rest.

In some implementations, dividing the change in device-to-frame orientation includes selecting a portion of the change in device-to-frame orientation to assign to the change in the estimated direction of motion of the entity, and the estimated direction of motion of the entity is updated based at least in part on an extent of the change in device-to-frame orientation, and the portion of the change in device-to-frame orientation assigned to the change in the estimated direction of motion of the entity. In other implementations, dividing the change in device-to-frame orientation includes selecting a portion of the change in device-to-frame orientation to assign to the change in the estimated device-to-entity orientation, the estimated direction of motion of the entity is updated based at least in part on an extent of the change in device-to-frame orientation, and the portion of the change in device-to-frame orientation assigned to the change in the estimated device-to-entity orientation.

In some implementations, the division of the change in the device-to-frame orientation between the change in the estimated direction of motion of the entity and the change in the estimated device-to-entity orientation is determined based at least in part on a radius of rotation of the change in the device-to-frame orientation. In these implementations, in accordance with a determination that the radius of rotation is above an entity-rotation threshold, the dividing optionally includes assigning all of the change in device-to-frame orientation to change in the estimated direction of motion of the entity, whereas in accordance with a determination that the radius of rotation is below a device-rotation threshold, the dividing optionally includes assigning all of the change in device-to-frame orientation to change in the estimated device-to-entity orientation. Further, in some implementations, the radius of rotation is determined based on a comparison between a measurement of angular acceleration and a measurement of linear acceleration. In other embodiments, when the motion of the entity is constrained to motion along a two-dimensional surface, the radius of rotation of the change in device-to-frame orientation corresponds to rotation about an axis perpendicular to the two-dimensional surface.

In some embodiments, method includes detecting a change in the device-to-frame orientation in each of a sequence of epochs, and for each respective epoch in the sequence of epochs, in response to detecting the change in the device-to-frame orientation during the respective epoch, assigning the change in the device-to-frame orientation to one of the estimated direction of motion of the entity and the estimated device-to-entity orientation to produce an updated direction of motion of the entity or an updated device-to-entity orientation.

In some embodiments, the entity is physically associated with the device when at least one of the following conditions occurs: the device is physically coupled to the entity, the device is coupled to the entity via a flexible connector that constrains motion of the device to an area proximate to the entity, the device is in a container that is physically coupled to the entity, and the device is held by the entity. Further, in some embodiments, the method includes determining a respective type of physical association between the device and the entity, and identifying one or more constraints corresponding to the respective type of physical association, where dividing the change in the device-to-frame orientation is based at least in part on the one or more constraints corresponding to the respective type of physical association.

In some embodiments, the method includes, in accordance with a determination that the direction of motion of the entity is constrained in accordance with a mode of transport of the entity, basing the division of the change in the device-to-frame orientation between the change in the estimated direction of motion of the entity and the change in the estimated device-to-entity orientation at least in part on constraints associated with the mode of transport of the entity.

In some embodiments, the entity is physically associated with a first device and a second device, and the method includes determining a device-to-frame orientation of the first device and a device-to-frame orientation of the second device, where the division of the change in a device-to-frame orientation is a division of a change in a device-to-frame orientation of the first device between the change in the estimated direction of motion of the entity and the change in the estimated device-to-entity orientation of the first device, and the division of the change in a device-to-frame orientation of the first device is based at least in part on a comparison between the change in device-to-frame orientation of the first device and a change in device-to-frame orientation of the second device.

In some embodiments, the method includes receiving external information corresponding to a direction of motion of the entity, and determining the estimated device-to-entity orientation of the device based on the external information and the device-to-frame orientation. In other embodiments, the method includes detecting a translational shift in the direction of motion of the device from a first direction to a second direction in accordance with translational-shift criteria, and in response to detecting the translational shift in the direction of motion of the entity, determining an angular difference between the first direction and the second direction and adjusting the estimated direction of motion of the entity and the estimated device-to-entity orientation in accordance with the angular difference. In these embodiments, the estimated direction of motion of the entity is optionally adjusted in a first direction, and the estimated device-to-entity orientation is optionally be adjusted in a second direction that is opposite to the first direction.

In some embodiments, the method includes estimating a location of the entity based on: an initial location estimate for the entity at a first time, the estimated direction of motion of the entity between the first time and a second time, an estimated stride length of the entity, and an estimated number of strides of the entity detected between the first time and the second time.

In some embodiments, the change in orientation of the device is determined based on sensor measurements from a set of self-contained sensors. In these embodiments, the set of self-contained sensors includes one or more of: a gyroscope, a multi-dimensional accelerometer, and a multi-dimensional magnetometer. In some embodiments, the change in orientation of the device is determined without reference to external signals from predefined artificial sources.

In accordance with some embodiments, a computer system (e.g., a navigation sensing device or a host computer system) includes one or more processors, memory, and one or more programs; the one or more programs are stored in the memory and configured to be executed by the one or more processors and the one or more programs include instructions for performing the operations of any of the methods described above. In accordance with some embodiments, a non-transitory computer readable storage medium (e.g., for use by a navigation sensing device or a host computer system) has stored therein instructions which when executed by one or more processors, cause a computer system (e.g., a navigation sensing device or a host computer system) to perform the operations of any of the methods described above.

### BRIEF DESCRIPTION OF THE DRAWINGS

FIG. 1 illustrates a system for using a navigation sensing device, according to some embodiments.

FIG. 2 is a block diagram illustrating an example navigation sensing device, according to some embodiments.

FIGS. 3A-3E are block diagrams illustrating configurations of various components of the system including a navigation sensing device, according to some embodiments.

FIG. 4 is a diagram illustrating an example of switching between a magnetometer-assisted mode of operation and an alternate mode of operation, according to some embodiments.

FIGS. 5A-5H are flow diagrams of a method for determining an estimated direction of motion of an entity, according to some embodiments.

FIG. 6 presents a block diagram of an example navigation sensing device, according to some embodiments.

FIG. 7 presents a block diagram of an example host computer system, according to some embodiments.

Like reference numerals refer to corresponding parts throughout the drawings.

### DESCRIPTION OF EMBODIMENTS

### Exemplary Use Cases

Navigation sensing devices (e.g., human interface devices or motion tracking device) that have a determinable multi-dimensional navigational state (e.g., one or more dimensions of displacement and/or one or more dimensions of rotation or attitude) are becoming increasingly common for providing input for many different applications. For example, such a navigation sensing device may be used as a motion tracking device to track changes in position and/or orientation of the device over time. These tracked changes can be used to map movements and/or provide other navigational state dependent services (e.g., location or orientation based alerts, etc.). In some situations, pedestrian dead reckoning (PDR) is used to determine changes in position of an entity that is physically associated with a device (e.g., by combining direction of motion information for the entity with stride count and stride length information). However, in circumstances where the physical coupling between the navigation sensing device and the entity is variable, the navigation sensing device uses sensor measurements to determine both changes in the physical coupling between the navigation sensing device and the entity (e.g., a “device-to-entity orientation”) and changes in direction of motion of the entity.

As another example, such a navigation sensing device may be used as a multi-dimensional pointer to control a pointer (e.g., a cursor) on a display of a personal computer, television, gaming system, etc. As yet another example, such a navigation sensing device may be used to provide augmented reality views (e.g., by overlaying computer generated elements over a display of a view of the real world) that change in accordance with the navigational state of the navigation sensing device so as to match up with a view of the real world that is detected on a camera attached to the navigation sensing device. In other situations, such a navigation sensing device may be used to provide views of a virtual world (e.g., views of portions of a video game, computer generated simulation, etc.) that change in accordance with the navigational state of the navigation sensing device so as to match up with a virtual viewpoint of the user based on the orientation of the device. In this document, the terms orientation, attitude and rotation are used interchangeably to refer to the orientation of a device or object with respect to a frame of reference. Additionally, a single navigation sensing device is optionally capable of performing multiple different navigation sensing tasks described above either simultaneously or in sequence (e.g., switching between a multi-dimensional pointer mode and a pedestrian dead reckoning mode based on user input).

In order to function properly (e.g., return results to the user that correspond to movements of the navigation sensing device in predictable ways), these applications rely on sensors that determine accurate estimates of the navigational state of the device. While specific use cases are described above and will be used to illustrate the general concepts described herein, it should be understood that these examples are non-limiting examples and that the embodiments described herein would apply in an analogous manner to any navigation sensing device that would benefit from an accurate estimate of the navigational state of the device.

### System Overview

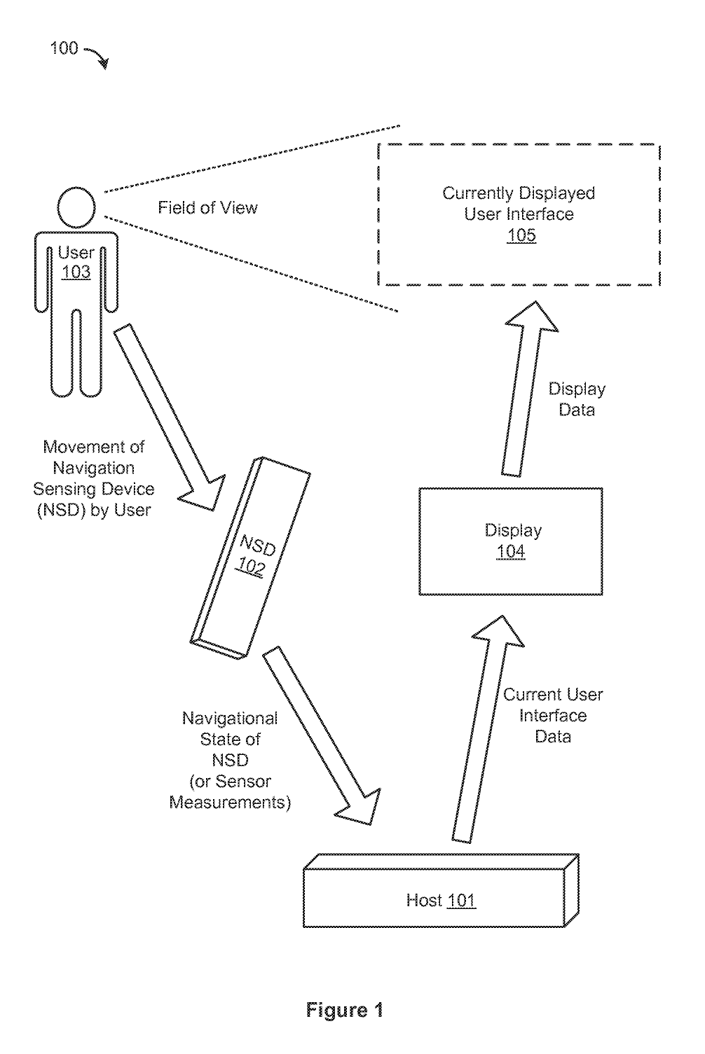

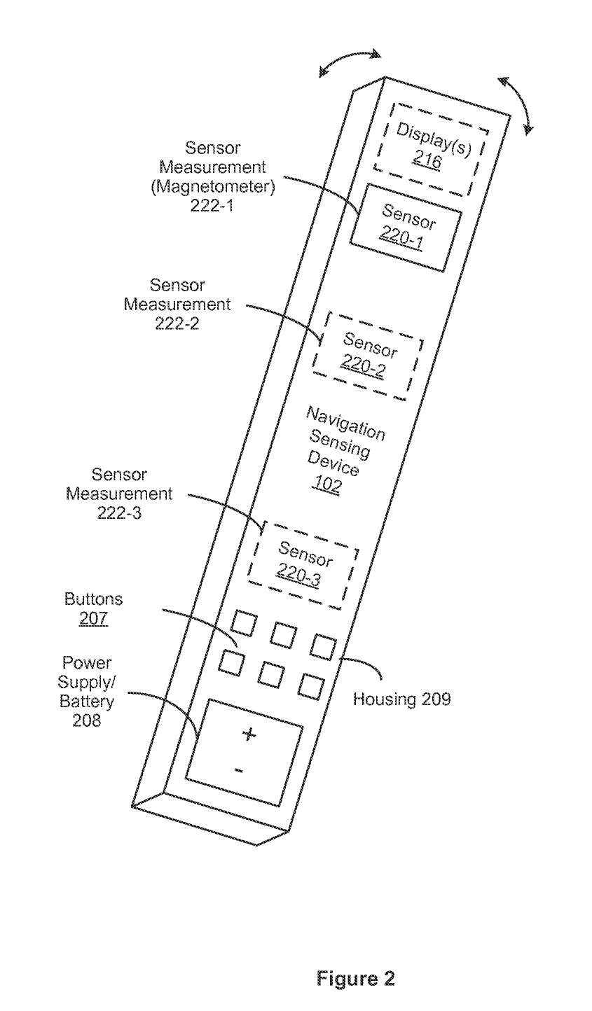

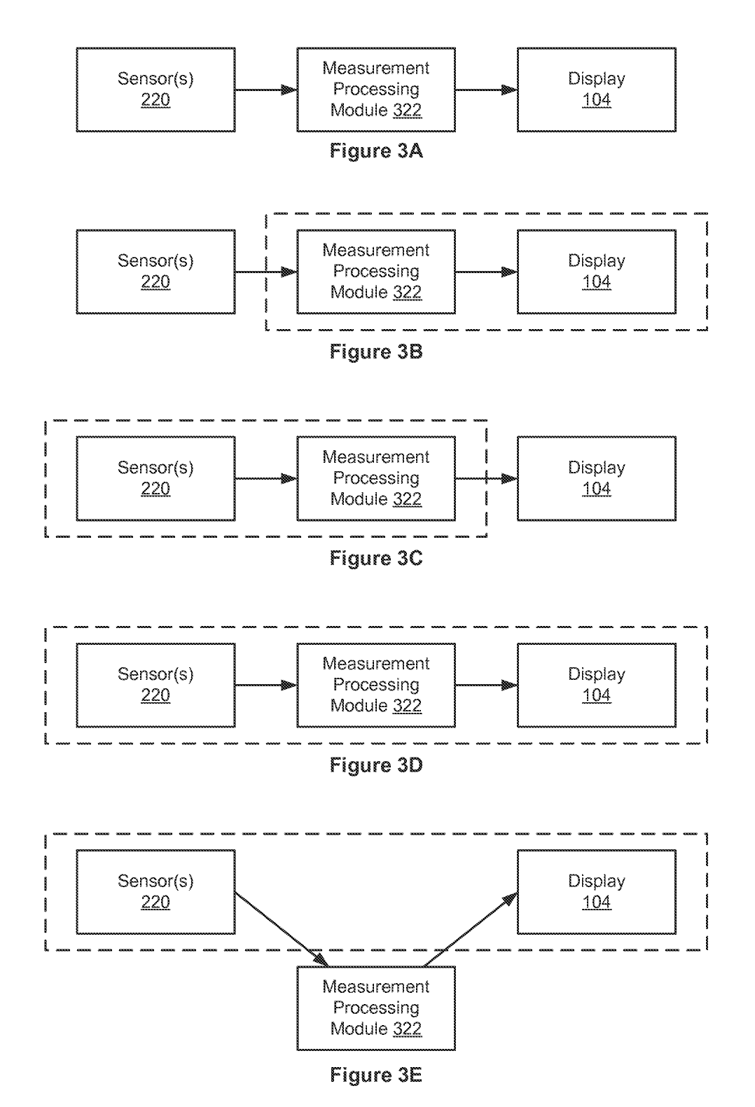

Attention is now directed to FIG. 1, which illustrates an example system 100 for using a navigation sensing device (e.g., a human interface device such as a multi-dimensional pointer) to manipulate a user interface. As shown in FIG. 1, an example Navigation Sensing Device 102 (hereinafter “Device 102”) is coupled to a Host Computer System 101 (hereinafter “Host 101”) through a wireless interface, according to some embodiments. In these embodiments, a User 103 moves Device 102. These movements are detected by sensors in Device 102, as described in greater detail below with reference to FIG. 2. Device 102, or Host 101, generates a navigational state of Device 102 based on sensor measurements from the sensors and transmits the navigational state to Host 101. Alternatively, Device 102 generates sensor measurements and transmits the sensor measurements to Host 101, for use in estimating a navigational state of Device 102. Host 101 generates current user interface data based on the navigational state of Device 102 and transmits the current user interface data to Display 104 (e.g., a display or a projector), which generates display data that is displayed to the user as the currently displayed User Interface 105. While Device 102, Host 101 and Display 104 are shown in FIG. 1 as being separate, in some embodiments the functions of one or more of these elements are combined or rearranged, as described in greater detail below with reference to FIGS. 3A-3E.

Thus, the user can use Device 102 to issue commands for modifying the user interface, control objects in the user interface, and/or position objects in the user interface by moving Device 102 so as to change its navigational state. In some embodiments, Device 102 is sensitive to six degrees of freedom: displacement along the x-axis, displacement along the y-axis, displacement along the z-axis, yaw, pitch, and roll.

In some other situations, Device 102 is a navigational state tracking device (e.g., a motion tracking device) that tracks changes in the navigational state of Device 102 over time but does not use these changes to directly update a user interface that is displayed to the user. For example, the updates in the navigational state can be recorded for later use by the user or transmitted to another user or can be used to track movement of the device and provide feedback to the user concerning their movement (e.g., directions to a particular location near the user based on an estimated location of the user). When used to track movements of a user without relying on external location information (e.g., Global Positioning System signals), such motion tracking devices are also sometimes referred to as pedestrian dead reckoning devices.

In some embodiments, the wireless interface is selected from the group consisting of: a Wi-Fi interface, a Bluetooth interface, an infrared interface, an audio interface, a visible light interface, a radio frequency (RF) interface, and any combination of the aforementioned wireless interfaces. In some embodiments, the wireless interface is a unidirectional wireless interface from Device 102 to Host 101. In some embodiments, the wireless interface is a bidirectional wireless interface. In some embodiments, bidirectional communication is used to perform handshaking and pairing operations. In some embodiments, a wired interface is used instead of or in addition to a wireless interface. As with the wireless interface, the wired interface is, optionally, a unidirectional or bidirectional wired interface.

In some embodiments, data corresponding to a navigational state of Device 102 (e.g., raw measurements, calculated attitude, correction factors, position information, etc.) is transmitted from Device 102 and received and processed on Host 101 (e.g., by a host side device driver). Host 101 uses this data to generate current user interface data (e.g., specifying a position of a cursor and/or other objects in a user interface) or tracking information.

Attention is now directed to FIG. 2, which illustrates an example of Device 102, according to some embodiments. In accordance with some embodiments, Device 102 includes one or more Sensors 220 which produce corresponding sensor outputs, which can be used to determine a navigational state of Device 102. For example, in one implementation, Sensor 220-1 is a multi-dimensional magnetometer generating multi-dimensional magnetometer measurements (e.g., a rotation measurement), Sensor 220-2 is a multi-dimensional accelerometer generating multi-dimensional accelerometer measurements (e.g., a rotation and translation measurement), and Sensor 220-3 is a gyroscope generating measurements (e.g., either a rotational vector measurement or rotational rate vector measurement) corresponding to changes in orientation of the device. In some implementations Sensors 220 include one or more of gyroscopes, beacon sensors, inertial measurement units, temperature sensors, barometers, proximity sensors, single-dimensional accelerometers and multi-dimensional accelerometers instead of or in addition to the multi-dimensional magnetometer and multi-dimensional accelerometer and gyroscope described above.

In some embodiments, Device 102 also includes one or more of: Buttons 207, Power Supply/Battery 208, Camera 214 and/or Display 216 (e.g., a display or projector). In some embodiments, Device 102 also includes one or more of the following additional user interface components: one or more processors, memory, a keypad, one or more thumb wheels, one or more light-emitting diodes (LEDs), an audio speaker, an audio microphone, a liquid crystal display (LCD), etc. In some embodiments, the various components of Device 102 (e.g., Sensors 220, Buttons 207, Power Supply 208, Camera 214 and Display 216) are all enclosed in Housing 209 of Device 102. However, in implementations where Device 102 is a pedestrian dead reckoning device, many of these features are not necessary, and Device 102 can use Sensors 220 to generate tracking information corresponding changes in navigational state of Device 102 and transmit the tracking information to Host 101 wirelessly or store the tracking information for later transmission (e.g., via a wired or wireless data connection) to Host 101.

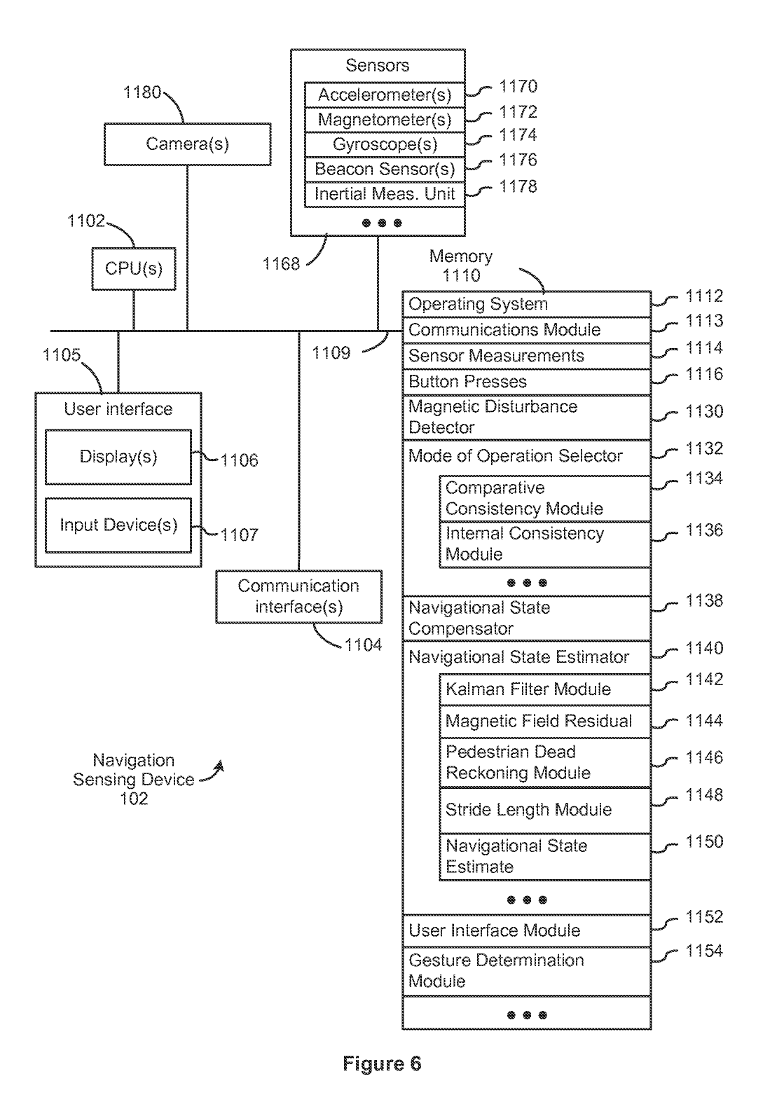

In some embodiments, one or more processors (e.g., 1102, FIG. 6) of Device 102 perform one or more of the following operations: sampling Sensor Measurements 222, at a respective sampling rate, produced by Sensors 220; processing sampled data to determine displacement; transmitting displacement information to Host 101; monitoring the battery voltage and alerting Host 101 when the charge of Battery 208 is low; monitoring other user input devices (e.g., keypads, buttons, etc.), if any, on Device 102 and, as appropriate, transmitting information identifying user input device events (e.g., button presses) to Host 101; continuously or periodically running background processes to maintain or update calibration of Sensors 220; providing feedback to the user as needed on the remote (e.g., via LEDs, etc.); and recognizing gestures performed by user movement of Device 102.

Attention is now directed to FIGS. 3A-3E, which illustrate configurations of various components of the system for generating navigational state estimates for a navigation sensing device. In some embodiments, there are three fundamental components to the system for determining a navigational state of a navigation sensing device described herein: Sensors 220, which provide sensor measurements that are used to determine a navigational state of Device 102, Measurement Processing Module 322 (e.g., a processing apparatus including one or more processors and memory) which uses the sensor measurements generated by one or more of Sensors 220 to generate estimates of the navigational state of Device 102 which can be used to determine current user interface data and/or track movement of Device 102 over time (e.g., using pedestrian dead reckoning), and, optionally, Display 104, which displays the currently displayed user interface to the user of Device 102 and/or information corresponding to movement of Device 102 over time. It should be understood that these components can be distributed among any number of different devices.

In some embodiments, Measurement Processing Module 322 (e.g., a processing apparatus including one or more processors and memory) is a component of the device including Sensors 220. In some embodiments, Measurement Processing Module 322 (e.g., a processing apparatus including one or more processors and memory) is a component of a computer system that is distinct from the device including Sensors 220. In some embodiments a first portion of the functions of Measurement Processing Module 322 are performed by a first device (e.g., raw sensor data is converted into processed sensor data at Device 102) and a second portion of the functions of Measurement Processing Module 322 are performed by a second device (e.g., processed sensor data is used to generate a navigational state estimate for Device 102 at Host 101).

As one example, in FIG. 3A, Sensors 220, Measurement Processing Module 322 and Display 104 are distributed between three different devices (e.g., a navigation sensing device such as a multi-dimensional pointer, a set top box, and a television, respectively; or a motion tracking device, a backend motion processing server and a motion tracking client). As another example, in FIG. 3B, Sensors 220 are included in a first device (e.g., a multi-dimensional pointer or a pedestrian dead reckoning device), while the Measurement Processing Module 322 and Display 104 are included in a second device (e.g., a host with an integrated display). As another example, in FIG. 3C, Sensors 220 and Measurement Processing Module 322 are included in a first device, while Display 104 is included in a second device (e.g., a “smart” multi-dimensional pointer and a television respectively; or a motion tracking device such as a pedestrian dead reckoning device and a display for displaying information corresponding to changes in the movement of the motion tracking device over time, respectively).

As yet another example, in FIG. 3D, Sensors 220, Measurement Processing Module 322 and Display 104 are included in a single device (e.g., a mobile computing device, such as a smart phone, personal digital assistant, tablet computer, pedestrian dead reckoning device etc.). As a final example, in FIG. 3E, Sensors 220 and Display 104 are included in a first device (e.g., a game controller with a display/projector), while Measurement Processing Module 322 is included in a second device (e.g., a game console/server). It should be understood that in the example shown in FIG. 3E, the first device will typically be a portable device (e.g., a smart phone or a pointing device) with limited processing power, while the second device is a device (e.g., a host computer system) with the capability to perform more complex processing operations, or to perform processing operations at greater speed, and thus the computationally intensive calculations are offloaded from the portable device to a host device with greater processing power. While a plurality of common examples have been described above, it should be understood that the embodiments described herein are not limited to the examples described above, and other distributions of the various components could be made without departing from the scope of the described embodiments.

### Using Multiple Sensors to Estimate Navigational States

In some implementations measurements from multiple sensors are used to estimate navigational states of Device 102 (e.g., via sensor fusion). For example, one combination of sensors that provide measurements that can be used to estimate navigational state (e.g., orientation and/or position) includes a gyroscope, one or more accelerometers, and one or more magnetometers. This navigational state data is used by other processes, such as pedestrian dead reckoning which uses changes in the navigational state over time to determine movement of Device 102.

Sometimes, sensor measurements from a respective sensor cannot be trusted because the sensor measurements differs too much from the expected model of sensor behavior for the respective sensor. For example, in many situations it is difficult or impossible to model translational acceleration for an accelerometer, and under the condition that there is translational acceleration present, sensor measurements from the accelerometer cannot be trusted (e.g., using these sensor measurements will result in introducing errors into the estimated navigational state).

Likewise, for the magnetometer, the expected model of sensor behavior for the magnetometer assumes that the local external magnetic field is uniform. If this assumption is violated (e.g., due to a local magnetic disturbance) the magnetometer measurements will be inaccurate and consequently the navigational state estimate and the other processes that depend on the navigational state estimate will be degraded. More specifically, the estimated navigational state will include erroneous gyroscope biases and/or erroneous headings angles (e.g., directions of motion of an entity associated with the device in the case of pedestrian dead reckoning). Therefore, it is beneficial to detect any uncompensated disturbances (e.g., a non-uniform disturbances in the magnetic field) and then to take steps to mitigate the effect of the resulting inaccuracies in magnetometer measurements on navigational state estimates for Device 102.

In this situation, the computer system switches to an alternative mode of operation (sometimes called “magnetic anomaly mode”), in which the effect of the sensor measurements from the magnetometer on the navigational state estimate is reduced. In the alternate mode of operation a gyroscope and/or one or more accelerometers are used to update navigational state estimates for Device 102 by integrating changes in the acceleration or angular rotation to determine movement of Device 102. In some embodiments, while the navigational state estimates for Device 102 are being generated in the alternate mode of operation, sensor measurements from the magnetometer are ignored altogether until the measurement model becomes accurate again (e.g., the non-uniform disturbance in the magnetic field is removed or ceases). In other embodiments, while the estimates navigational state estimates for Device 102 are being generated in the alternate mode of operation, the weight given to sensor measurements from the magnetometer is reduced until the measurement model becomes accurate again (e.g., the non-uniform disturbance in the magnetic field is removed). Detecting sensor anomalies and mitigating the effect of the sensor anomalies on navigational state determinations is improves the accuracy of navigational state determinations in many circumstance, but is particularly important when Device 102 does not have access to (or is not using) external signal inputs (e.g., GPS signals, IR beacons, sonic beacons or the like) to update the navigational state, such as when Device 102 is operating as a pedestrian dead reckoning device.

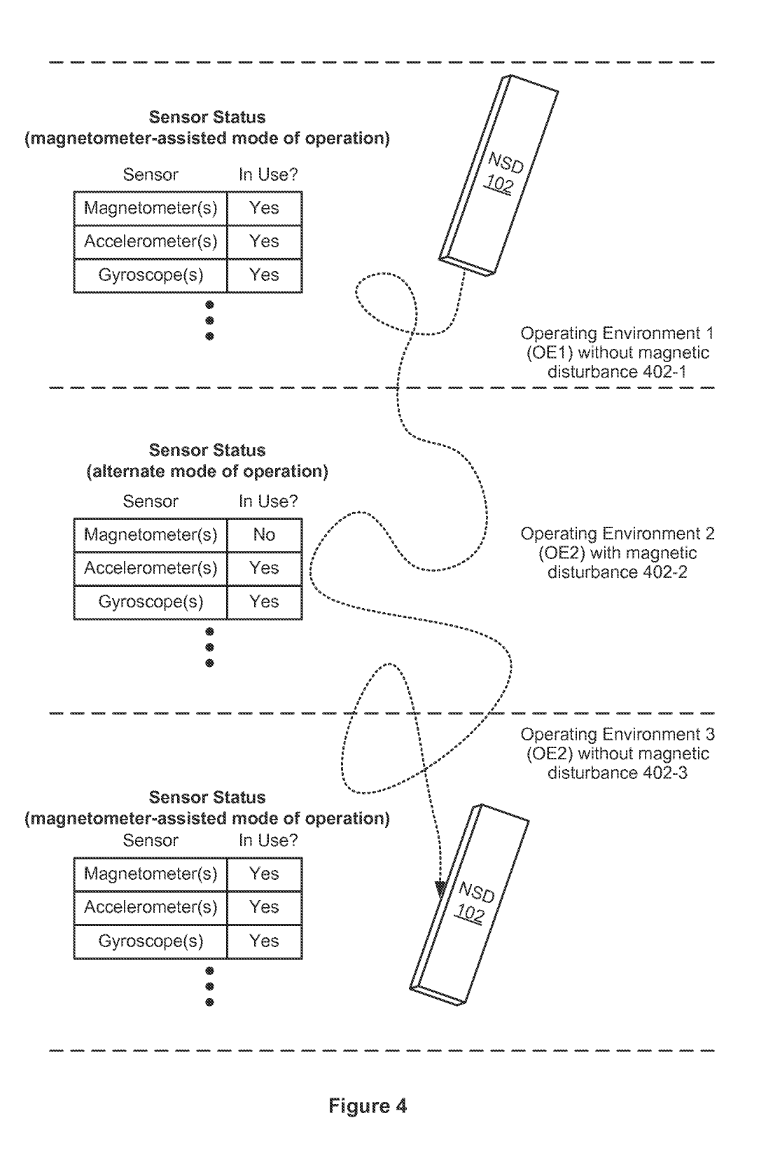

FIG. 4 illustrates an example of switching between a magnetometer-assisted mode of operation and an alternate mode of operation. Device 102 starts in a first operating environment, Operating Environment 1 (OE1) 402-1, which does not include a magnetic disturbance that substantially degrades performance of the magnetometer. While in the first operating environment, the magnetometer(s), accelerometer(s) and gyroscope(s) are used to update the navigational state of Device 102 by a processing apparatus operating in the magnetometer-assisted mode of operation. Subsequently, Device 102 moves from the first operating environment to a second operating environment, Operating Environment 2 (OE2) 402-2, which does include a magnetic disturbance that substantially degrades performance of the magnetometer (e.g., a non-uniform magnetic disturbance). For example Device 102 is placed on a large metal table or near a speakerphone or other electronic device that generates a strong magnetic field, the magnetic field near Device 102 will be distorted and produce magnetic field measurements that differ substantially from the reference magnetic field (e.g., the Earth's magnetic field). While in the second operating environment, the accelerometer(s) and gyroscope(s) are still used to update navigational state estimates for Device 102 by a processing apparatus operating in the alternate mode of operation where the magnetometer(s) are not used to updated the navigational state of Device 102. Subsequently, Device 102 moves from the second operating environment to a third operating environment, Operating Environment 3 (OE3) 402-3, which does not include a magnetic disturbance that substantially degrades performance of the magnetometer (e.g., a non-uniform magnetic disturbance). For example Device 102 is lifted off of the large metal table or moved away from the speakerphone or other electronic device that generates a strong magnetic field, so that the local magnetic field approximates the reference magnetic field (e.g., the Earth's magnetic field). While in the first operating environment, the magnetometer(s), accelerometer(s) and gyroscope(s) are used to update navigational state estimates for Device 102 by a processing apparatus operating in the magnetometer-assisted mode of operation (e.g., the processing apparatus returns to the magnetometer-assisted mode of operation).

In many situations when the non-uniform disturbance in the magnetic field is removed the measurement model will become accurate again (e.g., because the navigational state estimate has not drifted substantially from when the sensor measurements from the magnetometer ceased to be used to update the estimate of the navigational state). In these situations, the processing apparatus can transition from the alternate mode of operation to the magnetometer-assisted mode of operation when the measurement model becomes accurate again (e.g., the magnetic field measured by the magnetometer is in agreement with the magnetic field predicted based on measurements from the other sensors).

However, in other situations the estimate of the navigational state drifts while in the alternate mode of operation (e.g., because the navigation sensing device undergoes dynamic acceleration and/or the non-uniform disturbance in the magnetic field is present for too long a time). In these situations, the accumulation of attitude drift caused by integrating sensor measurements from the gyroscope and/or accelerometer(s) will cause the measurement model to always report too high an error to ever recover (e.g., return to a magnetometer-assisted mode of operation) and thus it is difficult to determine whether or not it is appropriate to transition from the alternate mode of operation to the magnetometer-assisted mode of operation. One possible approach to recovering from this situation where the magnetometer is not in use and the estimate of the navigational state has drifted, is to determine if the external field is uniform, even if the measurement model is not accurate, which indicates that the magnetometer is likely reliable but that the navigational state estimate drifted while in the alternate mode of operation.

Determination of external field uniformity is possible by attempting to estimate the magnetic field in the inertial frame (“h_{ref}”) over a variety of diverse orientations. If the external magnetic field is uniform, then the estimate of the magnetic field in the inertial frame (“h_{ref}”) should have a variance comparable to the sensor noise of the magnetometer. Once the estimate of the magnetic field in the inertial frame (“h_{ref}”) has been generated, an attitude correction that will compensate for the drift in the navigational state estimate can be determined and used to reintroduce the sensor measurements from the magnetometer to the navigational state estimation process, thereby returning to the magnetometer-assisted mode of operation. An example of one set of steps for transitioning from the alternate mode of operation to the magnetometer-assisted mode of operation is described below:

(1) Collect N “diverse” magnetometer measurements. A magnetometer measurement mᵢ is diverse from other measurements mⱼ if mᵢ^{T}mⱼ<β∀j≠i, where β is a defined constant.

(2) Compute an estimate of the inertial frame magnetic field h_{ref} from magnetometer measurements and the filters associated attitude estimates. (2a) Compute an inertial frame magnetic field direction for each magnetometer measurement: h_{ref}⁽ⁱ⁾=C^{T}(qⁱ)mᵢ∥mᵢ∥ where qⁱ is the attitude quaternion estimate and C (qⁱ) is the corresponding direction cosine matrix. (2b) Compute an estimate of the inertial magnetic field direction through the mean: ĥ_{ref}=(1/N)Σᵢ^{N}h_{ref}⁽ⁱ⁾.

(3) Check the uniformity of the estimated magnetic field. In a uniform field, the inertial frame magnetic field direction estimates for different magnetometer measurements should be consistent. In some embodiments, checking the uniformity of the estimated field includes checking the similarity of the individual estimates. The field is defined as uniform if σ²<α, where σ²=(1/N)Σᵢ^{N}(1−ĥ_{ref}^{T}h_{ref}⁽ⁱ⁾) and α is defined as a constant.

(4) If Device 102 is determined to be in a uniform field, apply attitude correction and resume normal operating mode. (4a) In the situation where the reference magnetic field is the Earth's magnetic field, the inertial frame magnetic field direction estimated from this algorithm should be corrected to have zero azimuth. (4b) Compute rotation matrix to transform estimated magnetic field into zero azimuth:

$$C = [ \begin{matrix}{\hat{h}}_{ref} ( 0 ) & {\hat{h}}_{ref} ( 1 ) & 0 \\ - {\hat{h}}_{ref} ( 1 ) & {\hat{h}}_{ref} ( 0 ) & 0 \\ 0 & 0 & 1\end{matrix} ] .$$

(4c) Compute new magnetic field direction vector using above rotation matrix, and feed the new magnetic field direction vector back to the attitude filter: h_{ref}=Cĥ_{ref}. (4d) Compute an attitude correction associated with above azimuth correction to be applied to any previous attitude estimates dq=f (C). This fixed attitude correction is used to correct for the attitude drift that occurred while the magnetometer was not being used to update navigational state estimates for Device 102. Additional details concerning determining a uniform magnetic field are described in greater detail in Provisional Application No. 61/615,327 entitled “System and Method for Determining a Uniform External Magnetic Field,” filed on Mar. 25, 2012, which is incorporated herein by reference in its entirety.

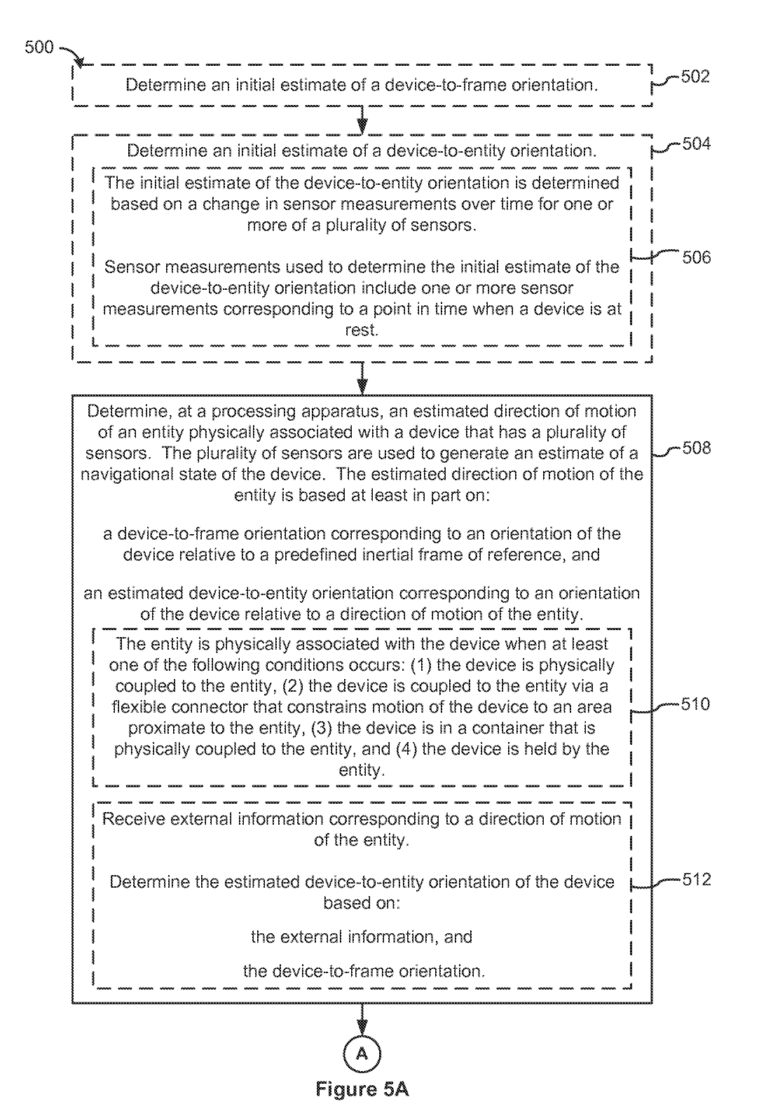

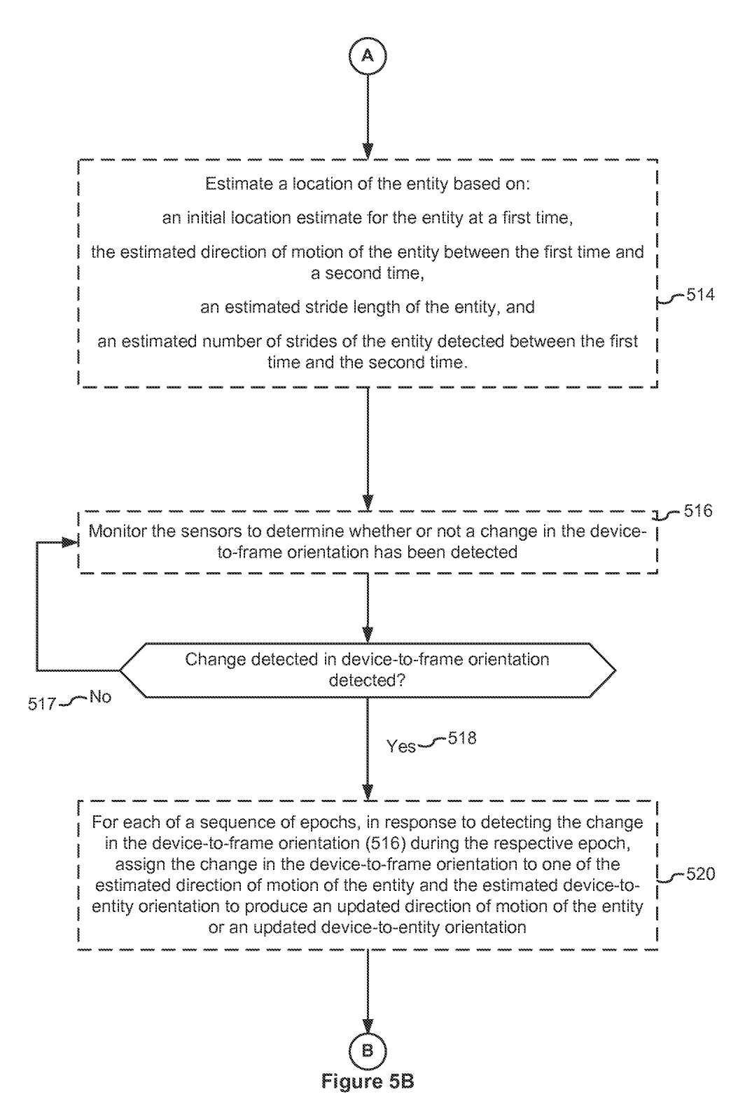

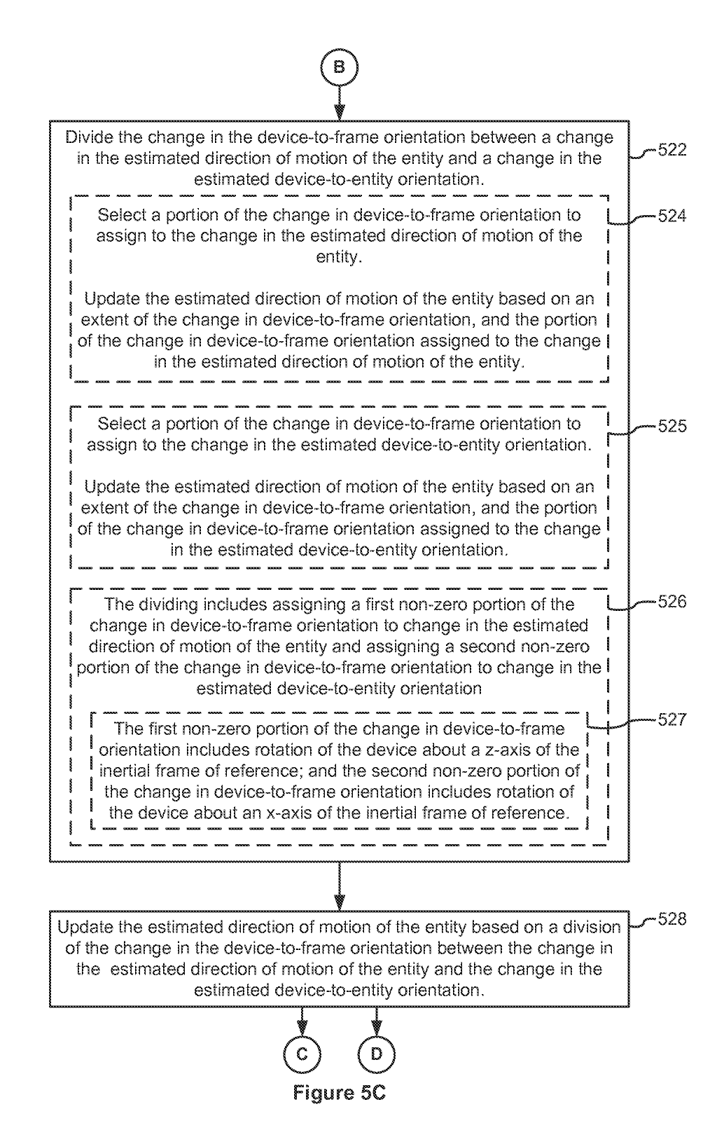

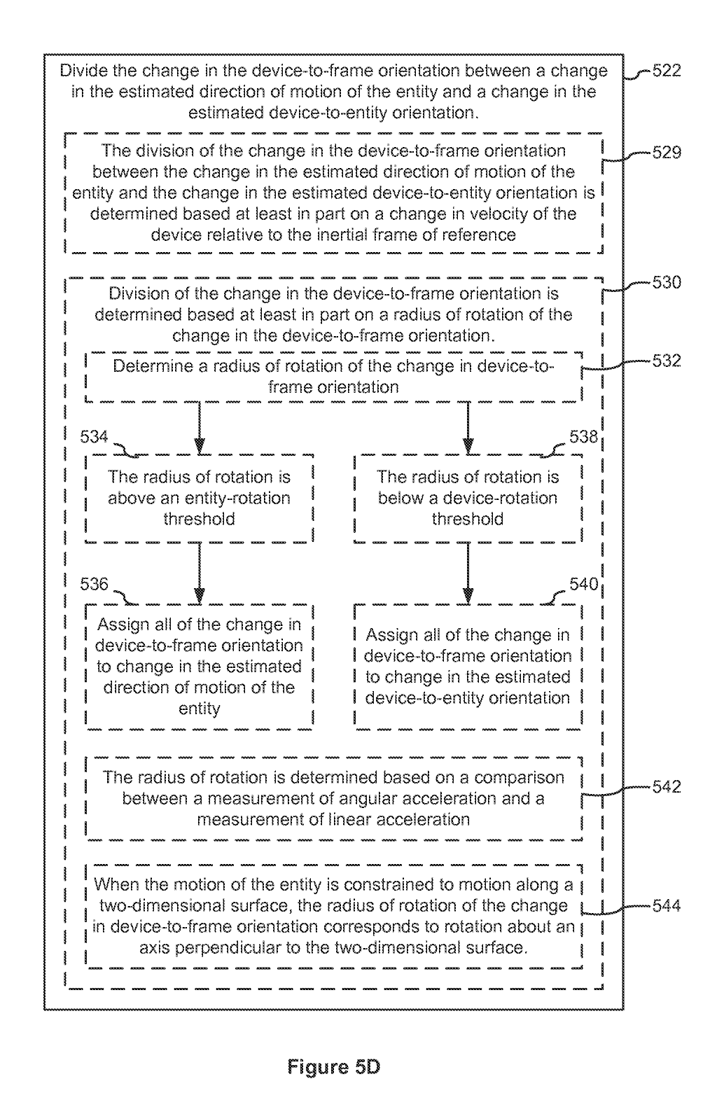

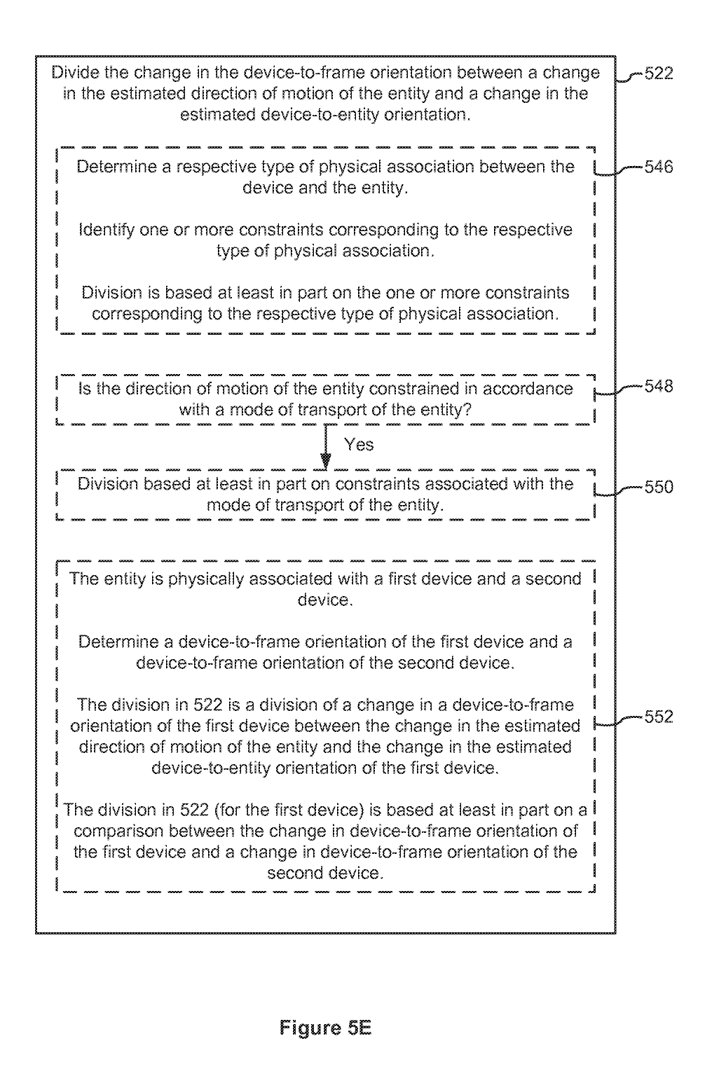

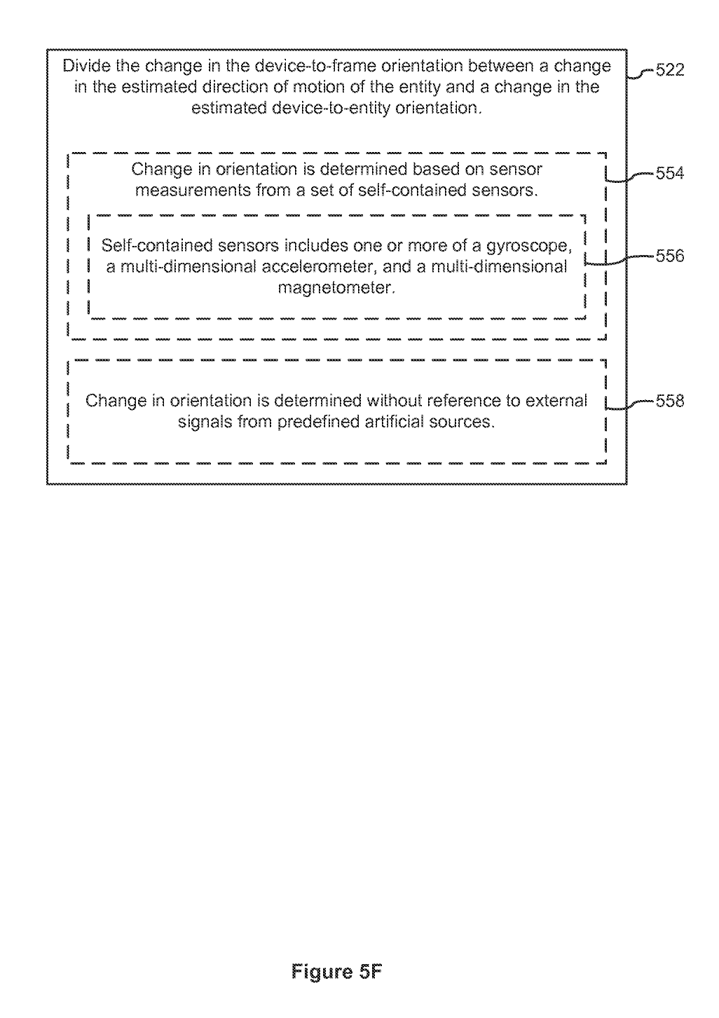

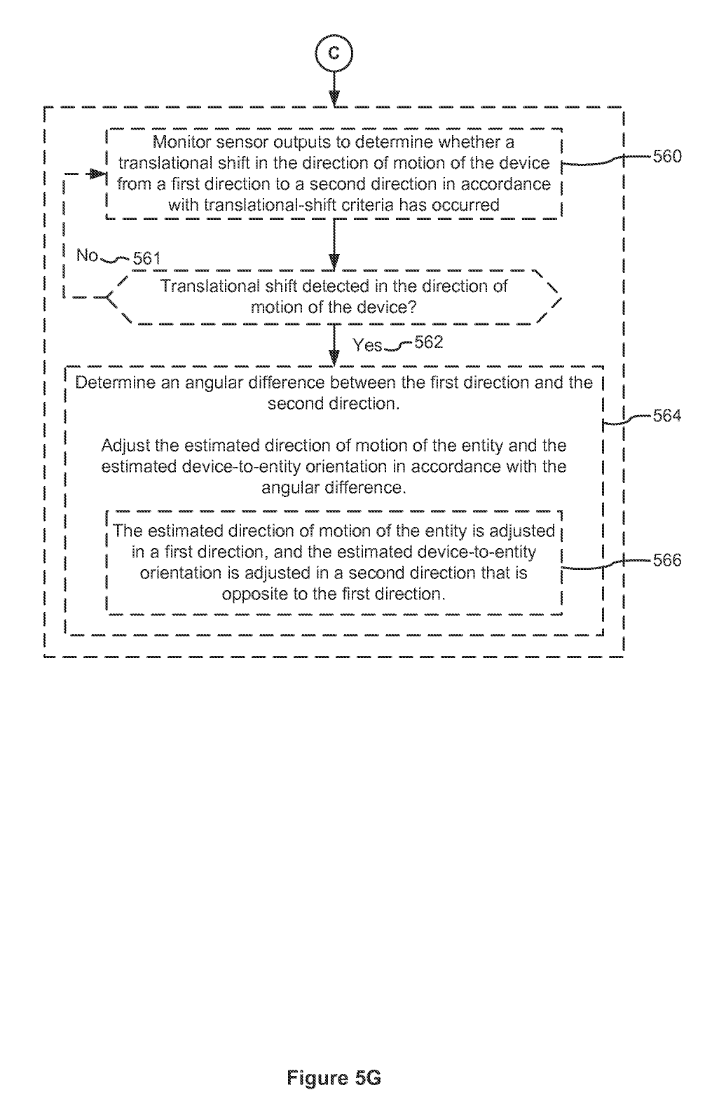

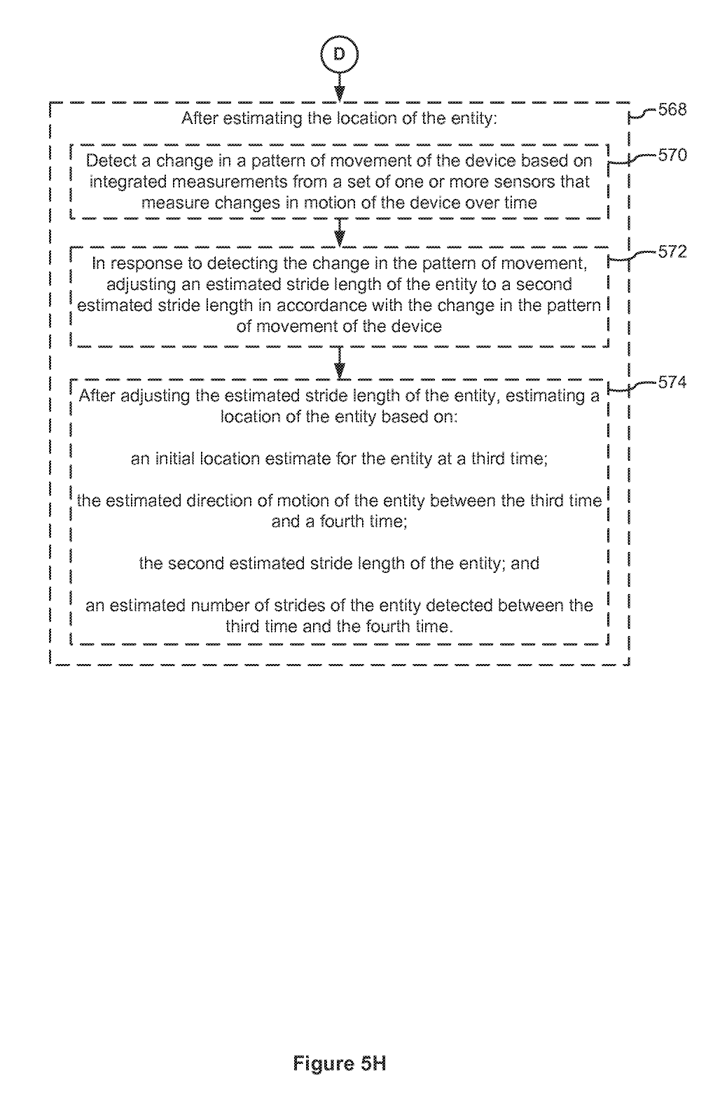

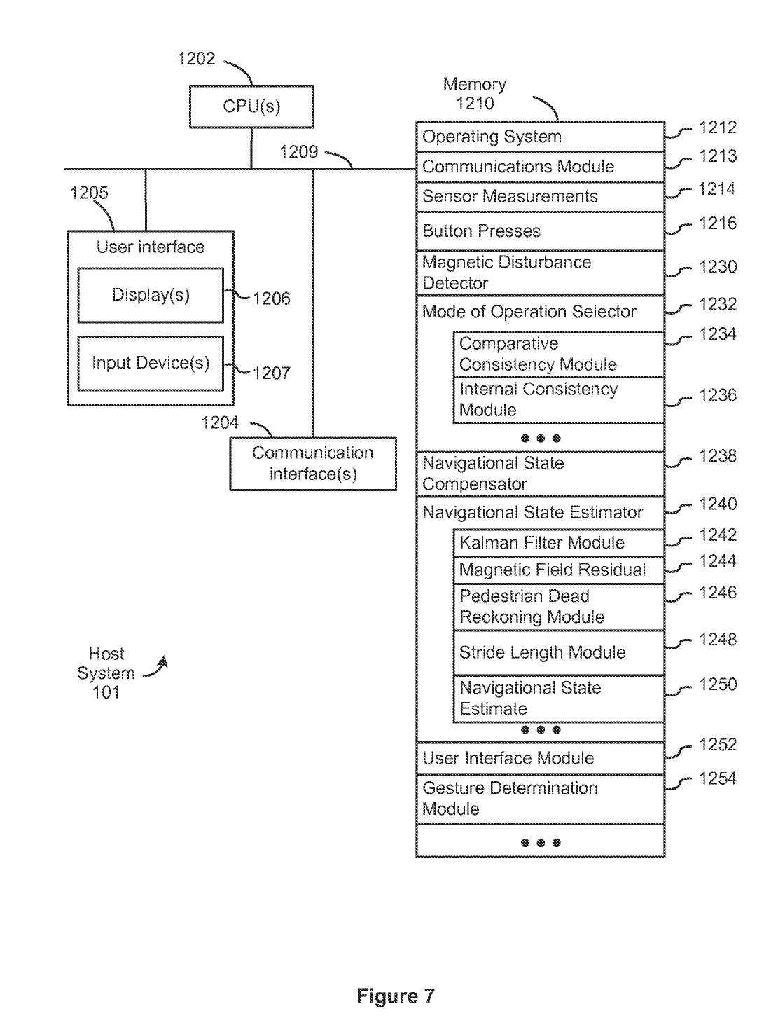

Attention is now directed to FIGS. 5A-5H, which illustrate a method 500 for determining an estimated direction of motion of an entity physically associated with a device (e.g., for use in pedestrian dead reckoning applications), in accordance with some embodiments. Method 500 is, optionally, governed by instructions that are stored in a non-transitory computer readable storage medium and that are executed by one or more processors of one or more computer systems (e.g., Device 102, FIG. 6 or Host 101, FIG. 7). Each of the operations shown in FIGS. 5A-5H typically corresponds to instructions stored in a computer memory or non-transitory computer readable storage medium (e.g., Memory 1110 of Device 102 in FIG. 6 or Memory 1210 of Host 101 in FIG. 7). The computer readable storage medium optionally (and typically) includes a magnetic or optical disk storage device, solid state storage devices such as Flash memory, or other non-volatile memory device or devices. The computer readable instructions stored on the computer readable storage medium typically include one or more of: source code, assembly language code, object code, or other instruction format that is interpreted or executed by one or more processors. In various embodiments, some operations in method 500 are combined and/or the order of some operations is changed from the order shown in FIGS. 5A-5H.

The following operations are performed at a processing apparatus having one or more processors and memory storing one or more programs that, when executed by the one or more processors, cause the respective processing apparatus to perform the method. In some embodiments, the processing apparatus is a component of Device 102 (e.g., the processing apparatus includes the one or more CPU(s) 1102 in FIG. 6). In some embodiments, the processing apparatus is separate from Device 102 (e.g., the processing apparatus includes the one or more CPU(s) 1202 in FIG. 7).

The processing apparatus determines (508) an estimated direction of motion of an entity physically associated with a device. The device has a plurality of sensors used to generate an estimate of a navigational state of the device (e.g., Device 102). The estimated direction of motion of the entity is based at least in part on a device-to-frame orientation, wherein the device-to-frame orientation corresponds to an orientation of the device relative to a predefined inertial frame of reference, and an estimated device-to-entity orientation, wherein the device-to-entity orientation corresponds to an orientation of the device relative to a direction of motion of the entity (e.g., User 103). In some embodiments, the estimated direction of motion is an anticipated or expected direction of motion of the entity (e.g., if the user of the device is not currently moving, the anticipated direction of motion would typically be the direction that the user is facing). In some embodiments, the device-to-frame orientation is calculated based on sensor measurements from one or more of the plurality of sensors.

In one example, method 500 determines an estimate of a direction of motion of an entity and employs three defined frames: the user frame (U), the inertial frame (I), and the device frame (D). The frames are related as follows:

R_{U}^{I}=R_{D}^{I}R_{U}^{D} (Eq. 1)

where R_{U}^{I} is the rotation matrix from user frame to inertial frame (sometimes called the “bearing” or “direction of motion” of the entity), R_{D}^{I} is the rotation matrix from the device frame to the inertial frame (sometimes called the “device-to-frame orientation” or “navigational state” of the device), and R_{U}^{D} describes the rotation from user frame to device frame (sometimes called the “device-to-entity orientation”). In some embodiments, the rotation matrix R_{D}^{I} is determined based on the detected navigational state of the device using one or more sensors (e.g., one or more gyroscopes, one or more magnetometers, and/or one or more accelerometers). Assuming that the environment surrounding the device remains constant (e.g., there are no dramatic non-uniform changes in magnetic or gravitational field), changes detected in the device-to-frame orientation are due either to a change in the device-to-entity orientation (e.g., as represented by R_{U}^{D}) or the direction of motion of the entity (e.g., as represented by R_{U}^{I}). As such, if the rotation matrix R_{U}^{D} is accurately estimated, then the bearing (e.g., estimated direction of motion of the entity) R_{U}^{I}, can be directly computed based on changes in the device-to-frame orientation determination made using the sensors. If the device-to-entity orientation is substantially fixed (e.g., a pedometer strapped to a user's shoe), then a simple fixed estimate of the device-to-entity orientation will be sufficient for most purposes. However, if the device-to-entity orientation shifts over time (e.g., for a smartphone or pedometer in a user's hand, pocket or purse), a more realistic approximation of the device-to-entity coupling will yield a more accurate estimate of the direction of motion of the entity.

In some implementations, prior to determining the estimated direction of motion of the entity, the processing apparatus determines (502) an initial estimate of the device-to-frame orientation. As an example, while the device is not moving, the processing apparatus determines a current orientation of the device relative to the inertial frame of reference (e.g., using sensor measurements from one or more sensors). Additionally, or alternatively in some implementations, prior to determining the estimated direction of motion of the entity, the processing apparatus determines (504) an initial estimate of the device-to-entity orientation. In some embodiments, the processing apparatus determines (506) the initial estimate of the device-to-entity orientation based on a change in sensor measurements over time for one or more of the plurality of sensors, where the sensor measurements include one or more sensor measurements corresponding to a point in time when the device is at rest. As an example, the initial estimate of the device-to-entity orientation is determined by integrating accelerometer measurements over a first few steps of the user, based on the assumption that the user is moving in a straight line and holding the device at a fixed orientation relative to the user.

For example, R_{U}^{D} and R_{U}^{I} are initialized by integrating accelerations of a device (e.g., Device 102) physically associated with the entity over a first two steps of walking More specifically, the process integrates accelerations from the start of walking to estimate δx^{I}, where x^{I} is the entity position in the inertial frame and δx^{I} is the direction/change in position of the entity in the inertial frame over the first two steps. In this example, for the first two steps, the device is assumed to have a substantially fixed orientation and position relative to the entity (e.g., so that changes in position of the device are attributed to changes in position of the entity). Then, R_{I}^{U} is constructed using δx^{I} as follows. First, the processing apparatus assumes that all horizontal motion is in the walking direction:

$$δ {x}^{U} = [ \begin{matrix}‖ δ {x}^{I} ( 1 : 2 ) ‖ \\ 0 \\ 0\end{matrix} ] = {( {R}_{U}^{I} )}^{T} δ {x}^{I} . \qquad ( Eq . 2 )$$

Then the method determines R_{U}^{I} as follows:

$${R}_{U}^{I} = \frac{1}{‖ δ {x}^{I} ( 1 : 2 ) ‖} [ \begin{matrix}δ {x}^{I} ( 1 ) & δ {x}^{I} ( 2 ) & 0 \\ δ {x}^{I} ( 2 ) & - δ {x}^{I} ( 1 ) & 0 \\ 0 & 0 & 1\end{matrix} ] . \qquad ( Eq . 3 )$$

(1c) Compute R_{U}^{D} using 4 as computed per Equation 3, along with the average R_{D}^{I} over the first two steps (e.g., the time-average of the device-to-frame orientation of the device averaged over the first two steps of walking):

R_{U}^{D}=(avg(R_{D}^{I}))^{T}R_{U}^{I}. (Eq. 4)

where an initial estimate of the rotational matrix R_{U}^{D} that corresponds to the device-to-entity orientation is computed based on the initial estimate of the rotational matrix R_{U}^{I} that corresponds to the entity-to-frame orientation and the rotational matrix R_{D}^{I} that corresponds to the detected device-to-frame orientation. As described above, equations 2-4 refer to a situation where movement of a user is averaged over a plurality of steps that includes at least a first step and a second step. In some embodiments, the motion of the user during the first step and the second step is in a same direction (e.g., the user walks in a straight line). In some embodiments, the motion of the user during the first step is in a first direction and the motion of the user during the second step is in a second direction that is different from the first direction (e.g., the user does not walk in a straight line for the first two steps).

In some embodiments, the entity is physically associated (510) with the device when at least one of the following conditions occurs: the device is physically coupled to the entity, the device is coupled to the entity via a flexible connector that constrains motion of the device to an area proximate to the entity (e.g., the device is connected to the entity via a lanyard, keychain, wrist strap, or a head-mounted apparatus such as a Bluetooth headset or a glasses mounted device), the device is in a container that is physically coupled to the entity (e.g., the device is in a pocket, bag, backpack, pocket, or briefcase that is held or worn by the user), and the device is held by the entity.

In some embodiments, the processing apparatus receives (512) external information corresponding to a direction of motion of the entity (sometimes referred to as “entity-to-frame orientation”), and determines the estimated device-to-entity orientation of the device based on the external information and the device-to-frame orientation. External information includes, for example, GPS signals or external information specifying the direction of motion of the entity. Additional examples of external information includes bearing derived from position measurements (e.g., from GPS, Wi-Fi, or another beacon-based system), as well as direct bearing measurements received from an external device or user input. As an example, the processing apparatus optionally combines the device-to-frame orientation (determined in accordance with sensor measurements from the plurality of sensors of the device) and external information corresponding to a direction of motion the entity to determine a more accurate estimate of the device-to-entity orientation. In some embodiments, the initial device-to-entity orientation is set based on the external information (e.g., instead of or in addition to the rotation matrix initialization described above with reference to equations 2-4). In some circumstances, the more accurate estimate of the device-to-entity orientation is determined in response to receiving the external information after performing one or more iterations of updating the device-to-entity orientation based on a radius of rotation of change to the device-to-frame orientation (e.g., as described below with reference to operation 520). For example, the device-to-entity orientation is re-initialized when a direct measurement of the direction of motion of the entity becomes available.

In some embodiments, the processing apparatus estimates (514) a location of the entity based on an initial location estimate for the entity at a first time, the estimated direction of motion of the entity between the first time and a second time, an estimated stride length of the entity, and an estimated number of strides of the entity detected between the first time and the second time. In some embodiments, the estimated direction of motion of the entity is combined with pedestrian dead reckoning to update a location of the entity. In some embodiments, stride length is a predefined value (e.g., a value that is specified by the user or a default value). In some embodiments, stride length is a user-specific value that is customized for the user. In some embodiments, stride length is fixed (e.g., the stride length does not change over time). In some embodiments, stride length is dynamic (e.g., the stride length for a particular user changes over time in accordance with changing conditions such as a frequency of steps of the user or a speed of movement of the user).

An example of determining a user-specific value of stride length that is customized for the user is described below with reference to equations 5-7. An estimated displacement of the device within an inertial frame of reference over a respective period of time (e.g., an amount of time during which one, two or three steps are detected) is determined based on sensor measurements (e.g., integration of accelerometer measurements, output of an inertial measurement unit or another combination of sensors). The estimated inertial displacement is divided by a number of steps detected during the respective period of time. For example, the following equations can be used to estimate a stride length (SL):

SL=∥x_{D}^{I}(tₛₜₑₚ₂)·x_{D}^{I}(tₛₜₑₚ₁)∥ (Eq. 5)

where x_{D}^{I} (tₛₜₑₚ₁) is the position (or estimated position) of the user at the time of step 1 and x_{D}^{I} (tₛₜₑₚ₂) is the position (or estimated position) of the user at the time of step 2. In some embodiments, the same information about stride length is determined based on a delta velocity (e.g., speed) of movement of the device relative to the inertial frame of reference between two steps sequentially adjacent steps multiplied and a time between the two sequentially adjacent steps, as shown in equation 6 below:

SL=∥v_{D}^{I}∥Δt_{step1→step2} (Eq. 6)

where v_{D}^{I} is the average velocity of the device relative to the inertial frame of reference between step 1 and step 2, and Δt_{step1→step2} is the amount of time between step 1 and step 2.

Additionally, for a more accurate estimate, the processing apparatus, optionally, averages the stride length over multiple steps as shown in equation 7 below:

$$\frac{Δ SL}{Δ t} = {‖ Δ {v}_{D}^{I} ‖}_{step M \to stepN} \qquad ( Eq . 7 )$$

where Δv_{D}^{I} is the delta velocity (e.g., average speed) of movement of the device (e.g., calculated based on integration of accelerometer measurements) relative to the inertial frame of reference between step M and step N and

$$\frac{Δ SL}{Δ t}$$

is, optionally, integrated with respect to time to determine a change in stride length between steps (ΔSL). In some embodiments, an average stride length for the user is determined and is used to determine an amount of movement of the user in a particular direction (e.g., via pedestrian dead reckoning). Even an average stride length for the user is more accurate than an average stride length that is not specific to the user (e.g., a generic stride length), because the average stride length will generally be closer to the user's actual stride length than the generic stride length.

Additionally, in some embodiments, stride length is adjusted in accordance with a detected step frequency. In some situations, stride length is estimated to vary linearly with step frequency using equation 8 below:

SL=∝fₛₜₑₚ+β (Eq. 8)

where ∝ and β are predetermined constants and fₛₜₑₚ is a frequency of steps of the user, so that the estimated stride length used for pedestrian dead reckoning is adjusted over time as the frequency of the user's steps changes (e.g., the user transitions from walking slowly to walking quickly to jogging to running or vice versa). In some embodiments, ∝ and β are user-specific parameters. In some embodiments ∝ and β are predefined. In some embodiments, ∝ and β are experimentally determined by repeatedly determining a stride length for different step frequencies of the user and performing a best fit match (e.g., a liner regression) to determine ∝ and β (e.g., the device experimentally determines the appropriate stride length to step frequency correlation and adjusts the user-specific stride length over time to account for changes in the user's stride length over time). In some embodiments, the processing apparatus starts with predefined values for ∝ and β and switches to using user-specific values for ∝ and β after sufficient data has been collected to perform a best fit operation and generate user-specific values for ∝ and β.

In some embodiments, while estimating the location of the entity based on the estimated direction of motion of the entity (e.g., using pedestrian dead reckoning), the processing apparatus monitors (516) the sensors to determine whether or not a change in the device-to-frame orientation has been detected. If no change in the device-to-frame orientation has been detected (517), then the processing apparatus continues to use the current direction of motion of the entity to estimate the location of the entity (e.g., using pedestrian dead reckoning). If the processing apparatus detects (516) a change in the device-to-frame orientation (e.g., when the device is rotated or the entity changes its direction of motion) the processing apparatus proceeds to update the estimated direction of motion of the entity or the estimated device-to-entity orientation, as described below with reference to operations 520-558. In response to detecting the change in the device-to-frame orientation (518), the processing apparatus divides (522, FIG. 5C) the change in the device-to-frame orientation between a change in the estimated direction of motion of the entity and a change in the estimated device-to-entity orientation (e.g., determining whether the change in device-to-frame orientation was due to a movement of the device relative to the user or a change in direction of the user), and updates (528) the estimated direction of motion of the entity based on the division of the change in the device-to-frame orientation between the change in the estimated direction of motion of the entity and the change in the estimated device-to-entity orientation, as described in greater detail below.

An example of dividing the change in the device-to-frame orientation between a change in the estimated direction of motion of the entity and a change in the estimated device-to-entity orientation is described below with reference to equations 9-20. Equation 1, (R_{U}^{I}=R_{D}^{I}R_{U}^{D}) can alternatively be written in quaternion form (e.g., using orientation quaternions) as:

q_{U→I}=q_{U→D} [symbol] q_{D→I} (Eq. 9)

where q_{Q→I} is the entity-to-frame orientation (e.g., corresponding to the rotation matrix from user frame to inertial frame (sometimes called the “bearing” or “direction of motion” of the entity)), q_{U→D} is the device-to-user orientation (e.g., corresponding to the rotation from user frame to device frame (sometimes called the “device-to-entity orientation”)), and q_{D→I} is the device-to-frame orientation (e.g., corresponding to the rotation matrix from the device frame to the inertial frame (sometimes called the “device-to-frame orientation” or “navigational state” of the device)). The quaternions in equation 9 can be rearranged for a given time t as:

q_{I→D}(t)=q_{I→U}(t)\textcircled{×}q_{U→D}(t) (Eq. 10)

at each of a plurality of time epochs, a new device-to-frame orientation is optionally obtained by the processing apparatus (e.g., from a combination of measurements from one or more sensors and, optionally, other information about a state of the device). Thus, in some embodiments, for time=t+1 the newly determined device-to-frame orientation is related to the other frame orientations, as follows:

q_{I→D}(t+1)=q_{I→D}(t+1)\textcircled{×}q_{U→D}(t+1) (Eq. 11)

q_{I→D}(t+1)=q_{I→U}(t)\textcircled{×}dq(t→t+1)\textcircled{×}q_{U→D}(t) (Eq. 12)

From equations 11-12 it can be seen that the bearing (e.g., entity to frame orientation) update at an epoch includes applying the effective delta rotation dq (t→t+1) to one or both of device-to-entity orientation (e.g., q_{I→U}(t)) or entity-to-device orientation (e.g., q_{U→D}(t)). Equation 12 can be rearranged to provide an estimate of the effective delta rotation.

dq(t→t+1)=q_{I→U}(t)\textcircled{×}q_{I→D}(t+1)\textcircled{×}q_{U→D}(t) (Eq. 13)

The effective delta rotation dq (t→t+1) can be divided between device-to-entity orientation and entity-to-frame orientation (e.g., bearing) either by assigning a non-zero portion of the effective delta rotation to the device-to-entity orientation and a non-zero portion of the effective delta rotation to the entity-to-frame orientation, assigning all of the effective delta rotation to either the device-to-entity orientation, or assigning all of the effective delta rotation to the entity-to-frame orientation.

In some embodiments, in each of a sequence of epochs (e.g., “measurement epochs” or “time steps”), the processing apparatus detects (520) a change in the device-to-frame orientation. In these embodiments, in response to detecting the change in the device-to-frame orientation during the respective epoch, the processing apparatus assigns the change in the device-to-frame orientation to one of the estimated direction of motion of the entity and the estimated device-to-entity orientation, to produce an updated direction of motion of the entity or an updated device-to-entity orientation. In some embodiments, in a first epoch the processing apparatus assigns the change in device-to-frame orientation detected during the first epoch primarily (or entirely) to a change in estimated direction of motion of the entity and in a second epoch (e.g., after the first epoch) the processing apparatus assigns the change in device-to-frame orientation detected during the second epoch primarily (or entirely) to a change in estimated device-to-entity orientation.

In some embodiments, dividing the change in device-to-frame orientation (e.g., the effective delta rotation dq(t→t+1)) includes the processing apparatus selecting (524) a portion of the change in device-to-frame orientation to assign to the change in the estimated direction of motion of the entity. In these embodiments, the estimated direction of motion of the entity is updated based at least in part on an extent of the change in device-to-frame orientation, and the portion of the change in device-to-frame orientation assigned to the change in the estimated direction of motion of the entity. For example, if the radius of rotation is of the same order of magnitude of the user's arm, the processing apparatus determines that the change in orientation of the device relative to the inertial frame of reference is primarily due to rotation of the user, and thus selects all of the change in orientation of the device relative to the inertial frame of reference as a change in the estimated direction of motion of the entity.

In some embodiments, if the processing apparatus does not have information indicating that what type of rotation has occurred, the processing apparatus uses a default assumption that the device-to-frame rotation is composed of both a change in device-to-entity orientation and a change in entity-to-frame orientation. In this case, the delta rotation is split into two components based on the axis of rotation:

dq(t→t+1)=dq_{z} [symbol] dq_{XY} (Eq. 14)

where dq_{Z} is the portion of rotation about the user Z axis (e.g., an “upright” axis of the user from head to toe), and dq_{XY} is the rotation about the user X axis and Y axis (e.g., axes that are perpendicular to the user Z axis extending from front to back and side to side of the user). In some embodiments, the user Z axis is assumed to be always aligned with inertial Z (i.e., the “upright” axis of the user doesn't roll or pitch relative to an axis perpendicular to gravity because the user is, in most circumstances, standing upright), and the user frame rotation is modified by Z axis rotations, thus the dq_{Z} portion of the rotation is used to update the user frame as below:

q_{I→U}(t+1)=q_{I→U}(t) [symbol] dq_{Z} (Eq. 15)

and the remaining delta rotation dq_{XY} is used to update the user to device rotation:

q_{U→D}(t+1)=q_{U→D}(t) [symbol] dq_{XY} (Eq. 16)

In situations where the processing apparatus does not have information indicating that what type of rotation has occurred, the processing apparatus optionally assumes that the user has not rotated relative to the inertial XY plane (e.g., the user has not rotated relative to the surface of the Earth and is still standing upright) and identifies (e.g., assigns) rotation relative to the inertial XY plane to rotation of the device relative to the user. In some embodiments, the remainder of the rotation (e.g., rotation relative to the inertial Z axis) is identified as (e.g., assigned to) rotation of the user relative to the inertial frame of reference and/or rotation of the device relative to the user.

In some embodiments, in accordance with a determination that the effective delta rotation is due entirely (or primarily) to a rotation of the device relative to the user, the full effective delta rotation is used to update the entity-to-device rotation and the entity-to-frame rotation (e.g., bearing) is kept fixed as shown in equations 17-18 below:

q_{I→U}(t+1)=q_{I→U}(t) (Eq. 17)

q_{U→D}(t+1)=dq(t→t+1) [symbol] q_{U→D}(t) (Eq. 18)

In some embodiments, the processing apparatus determines that the effective delta rotation is due entirely or primarily to a rotation of the device relative to the user when a large contiguous rotation is detected (e.g., the device just turned 90 degrees) and a radius of rotation algorithm indicates that the radius of rotation is consistent with a device rotation, as described in greater detail below with reference to equations 21-22. In some embodiments, the processing apparatus determines that the effective delta rotation is due entirely or primarily to a rotation of the device relative to the user when a large contiguous rotation is detected (e.g., the device just turned 90 degrees) and integration of a path of the device over the course of the rotation indicates that the direction of a velocity of the device in the inertial frame of reference over the course of the rotation is unchanged.

In some embodiments, in accordance with a determination that the effective delta rotation is due entirely (or primarily) to a rotation of the user relative to the inertial frame of reference, the full effective delta rotation is used to update the entity-to-frame orientation (e.g., bearing) and the entity-to-device rotation is kept fixed as shown in equations 19-20 below:

q_{U→D}(t+1)=q_{U→D}(t) (Eq. 19)

q_{I→U}(t+1)=q_{I→U}(t) [symbol] dq(t→t+1) (Eq. 20)

In some embodiments, the processing apparatus determines that the effective delta rotation is due entirely or primarily to a rotation of the device relative to the user when a large contiguous rotation is detected and a radius of rotation algorithm indicates that the radius of rotation is consistent with a user rotation relative to the inertial frame of reference, as described in greater detail below with reference to equations 21-22.

In some embodiments, dividing the change in device-to-frame orientation (e.g., the effective delta rotation dq(t→t+1)) includes the processing apparatus selecting (525) a portion of the change in device-to-frame orientation to assign to the change in the estimated device-to-entity orientation. In these embodiments, the estimated direction of motion of the entity is updated based at least in part on an extent of the change in device-to-frame orientation, and the portion of the change in device-to-frame orientation assigned to the change in the estimated device-to-entity orientation. For example, if the radius of rotation is of the same order of magnitude as the device's size (e.g., it's largest dimension), the processing apparatus determines that the change in orientation of the device relative to the inertial frame of reference is primarily due to rotation of the device about its own axis, and thus selects all of the change in orientation of the device relative to the inertial frame of reference as change in the estimated device-to-entity orientation.

In some embodiments, the dividing includes (526) assigning a first non-zero portion of the change in device-to-frame orientation to change in the estimated direction of motion of the entity and assigning a second non-zero portion of the change in device-to-frame orientation to change in the estimated device-to-entity orientation. In some embodiments, the first non-zero portion of the change in device-to-frame orientation includes (527) rotation of the device about a z-axis of the inertial frame of reference and the second non-zero portion of the change in device-to-frame orientation includes rotation of the device about an x-axis and/or a y-axis of the inertial frame of reference. In some embodiments, the z-axis is parallel to a direction of gravity or an “upright” direction of a user of the device. In some embodiments, the x-axis and the y-axis are perpendicular to a direction of gravity or an “upright” direction of a user of the device. In some embodiments, the y-axis extends in front and behind the user and the x-axis extends to the sides of the user.

In some embodiments, the division of the change in the device-to-frame orientation between the change in the estimated direction of motion of the entity and the change in the estimated device-to-entity orientation is determined (529) based at least in part on a change in velocity of the device relative to the inertial frame of reference. n some embodiments, when the change in inertial velocity of the device is above a predefined threshold that is consistent with rotation of the user, at least a portion of the change in the inertial velocity of the device is due to a change in motion of the entity.

In some embodiments, the division of the change in the device-to-frame orientation between the change in the estimated direction of motion of the entity and the change in the estimated device-to-entity orientation is determined (530) based at least in part on a radius of rotation of the change in the device-to-frame orientation.

In one example, for subsequent time steps after determining an estimated direction of motion of an entity, angular rate measurements are used to detect the presence of device rotations. If a rotation is detected, a processing apparatus can determine if the rotation is associated with body rotations or local device rotations as follows: (1) If there is no rotation about inertial Z (e.g., an axis perpendicular to the Earth's surface), the rotation is assumed to be due to a local device rotation relative to the user (e.g., a change in device-to-entity orientation), and all of the change in device-to-frame orientation is assigned to the device-to-entity orientation. (2) If there is rotation about inertial Z, then the processing apparatus estimates the radius of rotation, ρ, for the measured rotation. Assuming that linear acceleration has mean zero during walking, the measured device acceleration after removing a component of the linear acceleration that is due to gravity can be related to the total rotation rate and radius of rotation as follows:

α=ωₜₒₜₐₗ×(ωₜₒₜₐₗ×ρ) (Eq. 21)

where α is the acceleration, ωₜₒₜₐₗ is the total angular rotation and ρ is the radius of rotation. In some embodiments, the device includes sensors capable of detecting linear acceleration (e.g., a multi-dimensional accelerometer) and sensors capable of detecting angular rotation (e.g., a gyroscope). (3) Given the radius of rotation, estimate the underlying source of the rotation can be determined by the processing apparatus. (3a) In this example, the processing apparatus assumes that the total angular rotation can be broken into two components: angular rate of the device relative to the entity, and angular rate of the entity relative to the inertial frame:

ωₜₒₜₐₗ=ω_{EntityToInertial}+ω_{deviceToEntity} (Eq. 22)

In embodiments in which it is assumed that the two types of rotations do not occur simultaneously, the rotation is classified, based on the estimated radius of rotation and/or other factors, as one of these two types of rotation. In some implementations, a rotation type classifier is trained, using machine learning, on radius of rotation from several rotations of both types to determine the underlying type of rotation. Alternatively or in addition, a coarse estimate of whether the angular rotation detected by sensors of the device is primarily due to rotation of the device or primarily due to rotation of the entity is optionally made, based on a size of the determined radius of rotation, as described in greater detail below with reference to operations 532-544.

Continuing with the example, in the case where all of the device-to-frame rotation is assigned to either a change in direction of motion of the device or a change in device-to-entity orientation, the processing apparatus then updates the rotation matrices depending on the detected rotations above: (1) If rotations are due to rotation of the entity, the processing apparatus keeps R_{U}^{D} fixed, computes a current R_{D}^{I} using a standard attitude estimation algorithm, and updates R_{U}^{I}=R_{D}^{I}R_{U}^{D} to determine a new direction of motion of the entity. (2) If rotations are due to local device rotations, the processing apparatus keeps R_{U}^{I} fixed, computes a current R_{D}^{I} using a standard attitude estimation algorithm, and updates R_{U}^{D}=(R_{D}^{I})^{T}R_{U}^{I} to determine a new device-to-entity orientation that can be used to more accurately estimate future changes in the direction of motion of the entity. In other implementations where some of the change in device-to-frame orientation is assigned to a change in device-to-entity orientation and some of the change in device-to-frame orientation is assigned to a change in direction of motion of the device, changes to R_{U}^{I} and R_{U}^{D} would both be calculated while maintaining the equality R_{U}^{I}=R_{D}^{I}R_{U}^{D}.

In some embodiments, the processing apparatus determines (532) the radius of rotation of the change in device-to-frame orientation (e.g., based on a comparison between the linear acceleration and angular rotation of the device, as described in greater detail above with reference to equations 5-6). In some embodiments, in accordance with a determination that the radius of rotation is above (534) an entity-rotation threshold, the dividing includes assigning (536) all of the change in device-to-frame orientation to change in the estimated direction of motion of the entity. In contrast, in accordance with a determination that the radius of rotation is below (538) a device-rotation threshold, the dividing includes assigning (540) all of the change in device-to-frame orientation to change in the estimated device-to-entity orientation. In some embodiments, the device-rotation threshold and the entity-rotation threshold are the same. In some embodiments, the device-rotation threshold and the entity-rotation threshold are different. In some implementations, the device-rotation threshold is based on a size of the device. In some implementations, the entity-rotation threshold is based on a size (e.g., arm span, stride length, etc.) of the entity. In some embodiments, in accordance with a determination that the change in device-to-frame orientation includes a component corresponding to a change in the estimated direction of motion of the entity and a component corresponding to change in the estimated device-to-entity orientation (e.g., based on a determination that the radius of rotation is between the entity-rotation threshold and the device-rotation threshold), the device re-initializes the estimated device-to-entity orientation and/or the estimated direction of motion of the entity (e.g., as described above with reference to 506). For example, it may be difficult to classify changes in the device-to-frame orientation when the change in device-to-frame orientation is due to a mixed case where the user of the device is simultaneously rotating the device and changing a direction of motion. Alternatively, in some embodiments, when it is determined that the change in device-to-frame orientation was caused by a mix of device and entity rotation, a portion of the rotation is assigned to a change in the direction of motion of entity and a portion of the rotation is assigned to a change in device-to-entity orientation.

In some embodiments, the radius of rotation is determined (542) based on a comparison between a measurement of angular acceleration (e.g., from a gyroscope) and a measurement of linear acceleration (e.g., from a multi-dimensional accelerometer), as described above with reference to equations 5 and 6.

In some embodiments, when the motion of the entity is constrained to motion along a two-dimensional surface (e.g., the Earth's surface), the radius of rotation of the change in device-to-frame orientation corresponds (544) to rotation about an axis perpendicular to the two-dimensional surface (e.g., components of rotation that are orthogonal to the two-dimensional surface are ignored for the purposes of determining the radius of rotation). As an example, if a user of the device can move laterally on the x-y plane, the radius of rotation is a radius of rotation around the z-axis of the entity frame of reference, and rotation around the x-axis and/or y-axis of the entity frame of reference is ignored.

In some embodiments, the processing apparatus determines (546) a respective type of physical association between the device and the entity (e.g., one of the types of physical associations described above in step 510), and identifies one or more constraints corresponding to the respective type of physical association. In the same embodiments, dividing the change in the device-to-frame orientation is based at least in part on the one or more constraints corresponding to the respective type of physical association. For example, if it is known that the device is in the user's pocket, then any entity-frame z-axis orientation changes of the device are due to entity-to-frame orientation changes and not device-to-entity orientation changes (e.g., because the device is not changing in orientation relative to the user). In addition, the device-to-entity orientation can be constrained based on realistic orientations of a device in a pocket (for a typical flat, rectangular phone, the screen will be perpendicular to the ground when the user is standing or walking) In some implementations, similar algorithm adjustments/constraints are made for other types of physical association (e.g., in-container, flexible connector, or physically coupled).

In some embodiments, in accordance with a determination (548) that the direction of motion of the entity is constrained in accordance with a mode of transport of the entity (e.g., the direction of motion of the entity is subject to different constraints if the entity is walking, driving in a vehicle, or riding in an elevator), the division of the change in the device-to-frame orientation between the change in the estimated direction of motion of the entity and the change in the estimated device-to-entity orientation is based (550) at least in part on constraints associated with the mode of transport of the entity. If the entity is in an elevator, for example, the direction of motion of the entity just before entering the elevator will be either the same, or near opposite the direction of motion of the entity upon leaving the elevator (e.g., the configuration of the elevator doors restrict the user's direction of travel). As another example, if the entity is in a car, the radius of rotation associated with changes in the direction of motion of the entity can be restricted to a narrower range than the general case when the entity is walking, because cars have a larger turning radius than pedestrians (e.g., a car has a minimum threshold for the radius of rotation that is higher than the minimum threshold for the radius of rotation for a person).

In some embodiments, the entity is physically associated (552) with a first device and a second device. In these embodiments, the processing apparatus determines a device-to-frame orientation of the first device and a device-to-frame orientation of the second device. Furthermore, the division of the change in a device-to-frame orientation is a division of a change in a device-to-frame orientation of the first device between the change in the estimated direction of motion of the entity and the change in the estimated device-to-entity orientation of the first device. The division in step 552 (for the first device) is also based at least in part on a comparison between the change in the device-to-frame orientation of the first device and a change in the device-to-frame orientation of the second device. For example, if the entity is “physically associated” with more than one device, results of the estimation of the direction of motion of the entity from different devices can be combined to produce a better overall estimate of direction of motion of the entity. In other examples, the comparison between the change in the device-to-frame orientation of the first and second device is added to the direction of motion estimation process by imposing an additional constraint. In some implementations, the additional constraint is that the direction of motion of the entity determined by different devices must be the same.

In some embodiments, the change in orientation of the device is determined based on sensor measurements (554) from a set of self-contained sensors. For example, self-contained sensors optionally include sensors that do not require input from external beacons with known positional parameters (e.g., sonic beacons, light beacons, GPS satellites) to produce useful measurements. In some implementations, the set of self-contained sensors include (556) one or more of: a gyroscope, a multi-dimensional accelerometer, and a multi-dimensional magnetometer. In some embodiments, the change in orientation of the device is determined without reference (558) to external signals from predefined artificial sources. For example, the device optionally use sensors that do not require input from external beacons with known position or timing parameters (e.g., sonic beacons, light beacons, GPS satellites) to produce useful measurements. Examples of sensors that do not require input from external beacons optionally include sensors that generate measurements based solely on gravitational and magnetic fields.

In some embodiments, the processing apparatus monitors (560) sensor outputs of sensors of the device to determine whether a translational shift in the direction of motion of the device from a first direction to a second direction in accordance with translational-shift criteria has occurred. In some embodiments, if a translational shift is not detected (561), the processing apparatus continues to monitor the sensor outputs of sensors of the device. For example, the processing apparatus determines whether a large change in average direction of translational acceleration of the device has occurred without a corresponding change in device-to-frame orientation. In response to detecting the translational shift in the direction of motion of the entity (562), the processing apparatus determines (564) an angular difference between the first direction and the second direction, and adjusts the estimated direction of motion of the entity and the estimated device-to-entity orientation in accordance with the angular difference. In these embodiments, the estimated direction of motion of the entity is adjusted (566) in a first direction, and the estimated device-to-entity orientation is adjusted in a second direction that is opposite to the first direction.

In some embodiments, after estimating the location of the entity (e.g., as described in greater detail above with reference to step 514), the processing apparatus detects a change in a pattern of movement of the device based on integrated measurements from a set of one or more sensors that measure changes in motion of the device over time (e.g., a by integrating measurements from a three dimensional accelerometer to determine a velocity and/or change in position of the device). In some embodiments, detecting the change in pattern of movement of the device includes detecting a change in a frequency of steps of a user of the device. In some embodiments, in response to detecting the change in the pattern of movement, the processing apparatus adjusts an estimated stride length of the entity to a second estimated stride length in accordance with the change in the pattern of movement of the device (e.g., increasing the estimated stride length when the frequency of steps of the user increases and/or changing the estimated stride length when the distance estimate from an accelerometer generated by integrating acceleration measurements obtained during a set of one or more steps indicates that the estimated stride length is too short or too long). In some embodiments, after adjusting the estimated stride length of the entity, the processing apparatus estimates a location of the entity based on an initial location estimate for the entity at a third time, the estimated direction of motion of the entity between the third time and a fourth time, the second estimated stride length of the entity, and an estimated number of strides of the entity detected between the third time and the fourth time (e.g., using pedestrian dead reckoning).

It should be understood that the particular order in which the operations in FIGS. 5A-5H have been described are merely exemplary and are not intended to indicate that the described order is the only order in which the operations could be performed. One of ordinary skill in the art would recognize various ways to reorder the operations described herein.

### System Structure

FIG. 6 is a block diagram of Navigation sensing Device 102 (herein “Device 102”). Device 102 typically includes one or more processing units (CPUs) 1102, one or more network or other Communications Interfaces 1104 (e.g., a wireless communication interface, as described above with reference to FIG. 1), Memory 1110, Sensors 1168 (e.g., Sensors 220 such as one or more Accelerometers 1170, Magnetometers 1172, Gyroscopes 1174, Beacon Sensors 1176, Inertial Measurement Units 1178, Thermometers, Barometers, and/or Proximity Sensors, etc.), one or more Cameras 1180, and one or more Communication Buses 1109 for interconnecting these components. In some embodiments, Communications Interfaces 1104 include a transmitter for transmitting information, such as accelerometer and magnetometer measurements, and/or the computed navigational state of Device 102, and/or other information to Host 101. Communication buses 1109 typically include circuitry (sometimes called a chipset) that interconnects and controls communications between system components. Device 102 optionally includes user interface 1105 comprising Display 1106 (e.g., Display 104 in FIG. 1) and Input Devices 1107 (e.g., keypads, buttons, etc.). Memory 1110 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 1110 optionally includes one or more storage devices remotely located from the CPU(s) 1102. Memory 1110, or alternately the non-volatile memory device(s) within Memory 1110, comprises a non-transitory computer readable storage medium. In some embodiments, Memory 1110 stores the following programs, modules and data structures, or a subset thereof:
Operating System 1112 that includes procedures for handling various basic system services and for performing hardware dependent tasks;
Communication Module 1113 that is used for connecting Device 102 to Host 101 via Communication Network Interface(s) 1104 (wired or wireless); Communication Module 1113 is optionally adapted for connecting Device 102 to one or more communication networks, such as the Internet, other wide area networks, local area networks, metropolitan area networks, and so on;
Sensor Measurements 1114 (e.g., data representing accelerometer measurements, magnetometer measurements, gyroscope measurements, global positioning system measurements, beacon sensor measurements, inertial measurement unit measurements, thermometer measurements, atmospheric pressure measurements, proximity measurements, etc.);
data representing Button Presses 1116;
Magnetic Disturbance Detector 1130 for detecting disturbances in the local magnetic field of Device 102 (e.g., detecting sudden changes in magnetic field direction that do not correspond to changes in navigational state of Device 102 and/or detecting that the local magnetic field is non-uniform);
Mode of Operation Selector 1132, for selecting a mode of operation for the processing apparatus (e.g., the magnetometer-assisted mode or the alternate mode), which optionally includes Comparative Consistency Module 1134 for determining whether magnetometer measurements are consistent with other sensor measurements and Internal Consistency Module 1136 for determining whether magnetometer measurements are internally consistent (e.g., that Device 102 is in a uniform magnetic field);
Navigational State Compensator 1138 for determining a fixed compensation (e.g., a rotational offset) for compensating for drift in the navigational state estimate while the processing apparatus was in the alternate mode of operation;
Navigation State Estimator 1140 for estimating navigational states of Device 102, optionally including:
   Kalman Filter Module 1142 that determines the attitude of Device 102, as described in U.S. Pat. Pub. No. 2010/0174506 Equations 8-29, wherein the Kalman filter module includes: a sensor model (e.g., the sensor model described in Equations 28-29 of U.S. Pat. Pub. No. 2010/0174506), a dynamics model (e.g., the dynamics model described in Equations 15-21 of U.S. Pat. Pub. No. 2010/0174506), a predict module that performs the predict phase operations of the Kalman filter, an update module that performs the update operations of the Kalman filter, a state vector of the Kalman filter (e.g., the state vector \hat{x} in Equation 10 of U.S. Pat. Pub. No. 2010/0174506), a mapping, Kalman filter matrices, and attitude estimates (e.g., the attitude estimates as obtained from the quaternion in the state vector 2 in Equation 10 of U.S. Pat. Pub. No. 2010/0174506);
   Magnetic Field Residual 1144 that is indicative of a difference between a magnetic field detected based on measurements from Magnetometer(s) 1172 and a magnetic field estimated based on Kalman Filter Module 1142;
   Pedestrian Dead Reckoning Module 1146, for determining a direction of motion of the entity and updating a position of the device in accordance with the direction of motion of the entity, stride length, and stride count (additional details regarding pedestrian dead reckoning can be found in A. Jimenez, F. Seco, C. Prieto, and J. Guevara, “A comparison of Pedestrian Dead-Reckoning algorithms using a low-cost MEMS IMU,” IEEE International Symposium on Intelligent Signal Processing 26-28 Aug. 2009, p. 37-42, which is incorporated herein by reference in its entirety;
   Stride Length Module 1148, for determining stride length; and
   data representing Navigational State Estimate 1150 (e.g., an estimate of the position and/or attitude of Device 102).
optionally, User Interface Module 1152 that receives commands from the user via Input Device(s) 1107 and generates user interface objects in Display(s) 1106 in accordance with the commands and the navigational state of Device 102, User Interface Module 1152 optionally includes one or more of: a cursor position module for determining a cursor position for a cursor to be displayed in a user interface in accordance with changes in a navigational state of the navigation sensing device, an augmented reality module for determining positions of one or more user interface objects to be displayed overlaying a dynamic background such as a camera output in accordance with changes in a navigational state of the navigation sensing device, a virtual world module for determining a portion of a larger user interface (a portion of a virtual world) to be displayed in accordance with changes in a navigational state of the navigation sensing device, a pedestrian dead reckoning module for tracking movement of Device 102 over time, and other application specific user interface modules; and
optionally, Gesture Determination Module 1154 for determining gestures in accordance with detected changes in the navigational state of Device 102.

It is noted that in some of the embodiments described above, Device 102 does not include a Gesture Determination Module 1154, because gesture determination is performed by Host 101. In some embodiments described above, Device 102 also does not include Magnetic Disturbance Detector 1130, Mode of Operation Selector 1132, Navigational State Estimator 1140 and User Interface Module because Device 102 transmits Sensor Measurements 1114 and, optionally, data representing Button Presses 1116 to a Host 101 at which a navigational state of Device 102 is determined.

Each of the above identified elements may be stored in one or more of the previously mentioned memory devices, and each of the above identified programs or modules corresponds to a set of instructions for performing a function described above. The set of instructions can be executed by one or more processors (e.g., CPUs 1102). The above identified modules or programs (i.e., sets of instructions) need not be implemented as separate software programs, procedures or modules, and thus various subsets of these modules may be combined or otherwise re-arranged in various embodiments. In some embodiments, Memory 1110 may store a subset of the modules and data structures identified above. Furthermore, Memory 1110 may store additional modules and data structures not described above.

Although FIG. 6 shows a “Navigation sensing Device 102,” FIG. 6 is intended more as functional description of the various features which may be present in a navigation sensing device. In practice, and as recognized by those of ordinary skill in the art, items shown separately could be combined and some items could be separated.

FIG. 7 is a block diagram of Host Computer System 101 (herein “Host 101”). Host 101 typically includes one or more processing units (CPUs) 1202, one or more network or other Communications Interfaces 1204 (e.g., any of the wireless interfaces described above with reference to FIG. 1), Memory 1210, and one or more Communication Buses 1209 for interconnecting these components. In some embodiments, Communication Interfaces 1204 include a receiver for receiving information, such as accelerometer and magnetometer measurements, and/or the computed attitude of a navigation sensing device (e.g., Device 102), and/or other information from Device 102. Communication Buses 1209 optionally include circuitry (sometimes called a chipset) that interconnects and controls communications between system components. Host 101 optionally includes a User Interface 1205 comprising a Display 1206 (e.g., Display 104 in FIG. 1) and Input Devices 1207 (e.g., a navigation sensing device such as a multi-dimensional pointer, a mouse, a keyboard, a trackpad, a trackball, a keypad, buttons, etc.). Memory 1210 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 1210 optionally includes one or more storage devices remotely located from the CPU(s) 1202. Memory 1210, or alternately the non-volatile memory device(s) within Memory 1210, comprises a non-transitory computer readable storage medium. In some embodiments, Memory 1210 stores the following programs, modules and data structures, or a subset thereof:
Operating System 1212 that includes procedures for handling various basic system services and for performing hardware dependent tasks;
Communication Module 1213 that is used for connecting Host 101 to Device 102, and/or other devices or systems via Communication Network Interface(s) 1204 (wired or wireless), and for connecting Host 101 to one or more communication networks, such as the Internet, other wide area networks, local area networks, metropolitan area networks, and so on;
Sensor Measurements 1214 (e.g., data representing accelerometer measurements, magnetometer measurements, gyroscope measurements, global positioning system measurements, beacon sensor measurements, inertial measurement unit measurements, thermometer measurements, atmospheric pressure measurements, proximity measurements, etc.);
data representing Button Presses 1216;
Magnetic Disturbance Detector 1230 for detecting disturbances in the local magnetic field of Device 102 (e.g., detecting sudden changes in magnetic field direction that do not correspond to changes in navigational state of Device 102 and/or detecting that the local magnetic field is non-uniform);
Mode of Operation Selector 1232, for selecting a mode of operation for the processing apparatus (e.g., the magnetometer-assisted mode or the alternate mode), which optionally includes Comparative Consistency Module 1234 for determining whether magnetometer measurements for Device 102 are consistent with other sensor measurements for Device 102 and Internal Consistency Module 1236 for determining whether magnetometer measurements are internally consistent (e.g., that Device 102 is in a uniform magnetic field);
Navigational State Compensator 1238 for determining a fixed compensation (e.g., a rotational offset) for compensating for drift in the navigational state estimate of Device 102 while the processing apparatus was in the alternate mode of operation;
Navigation State Estimator 1240 for estimating navigational states of Device 102, optionally including:
   Kalman Filter Module 1242 that determines the attitude of Device 102, as described in U.S. Pat. Pub. No. 2010/0174506 Equations 8-29, wherein the Kalman filter module includes: a sensor model (e.g., the sensor model described in Equations 28-29 of U.S. Pat. Pub. No. 2010/0174506), a dynamics model (e.g., the dynamics model described in Equations 15-21 of U.S. Pat. Pub. No. 2010/0174506), a predict module that performs the predict phase operations of the Kalman filter, an update module that performs the update operations of the Kalman filter, a state vector of the Kalman filter (e.g., the state vector 2 in Equation 10 of U.S. Pat. Pub. No. 2010/0174506), a mapping, Kalman filter matrices, and attitude estimates (e.g., the attitude estimates as obtained from the quaternion in the state vector 2 in Equation 10 of U.S. Pat. Pub. No. 2010/0174506);
   Magnetic Field Residual 1244 that is indicative of a difference between a magnetic field detected based on measurements from Magnetometer(s) 1272 and a magnetic field estimated based on Kalman Filter Module 1242;
   Pedestrian Dead Reckoning Module 1246, for determining a direction of motion of the entity and updating a position of the device in accordance with the direction of motion of the entity, stride length and stride count;
   Stride Length Module 1248, for determining stride length; and
   data representing Navigational State Estimate 1250 (e.g., an estimate of the position and/or attitude of Device 102).
optionally, User Interface Module 1252 that receives commands from the user via Input Device(s) 1207 and generates user interface objects in Display(s) 1206 in accordance with the commands and the navigational state of Device 102, User Interface Module 1252 optionally includes one or more of: a cursor position module for determining a cursor position for a cursor to be displayed in a user interface in accordance with changes in a navigational state of the navigation sensing device, an augmented reality module for determining positions of one or more user interface objects to be displayed overlaying a dynamic background such as a camera output in accordance with changes in a navigational state of the navigation sensing device, a virtual world module for determining a portion of a larger user interface (a portion of a virtual world) to be displayed in accordance with changes in a navigational state of the navigation sensing device, a pedestrian dead reckoning module for tracking movement of Device 102 over time, and other application specific user interface modules; and
optionally, Gesture Determination Module 1254 for determining gestures in accordance with detected changes in the navigational state of Device 102.

It is noted that in some of the embodiments described above, Host 101 does not store data representing Sensor Measurements 1214, because sensor measurements of Device 102 are processed at Device 102, which sends data representing Navigational State Estimate 1250 to Host 101. In other embodiments, Device 102 sends data representing Sensor Measurements 1214 to Host 101, in which case the modules for processing that data are present in Host 101.

Each of the above identified elements may be stored in one or more of the previously mentioned memory devices, and each of the above identified programs or modules corresponds to a set of instructions for performing a function described above. The set of instructions can be executed by one or more processors (e.g., CPUs 1202). The above identified modules or programs (i.e., sets of instructions) need not be implemented as separate software programs, procedures or modules, and thus various subsets of these modules may be combined or otherwise re-arranged in various embodiments. The actual number of processors and software modules used to implement Host 101 and how features are allocated among them will vary from one implementation to another. In some embodiments, Memory 1210 may store a subset of the modules and data structures identified above. Furthermore, Memory 1210 may store additional modules and data structures not described above.

Note that method 500 described above is optionally governed by instructions that are stored in a non-transitory computer readable storage medium and that are executed by one or more processors of Device 102 or Host 101. As noted above, in some embodiments these methods may be performed in part on Device 102 and in part on Host 101, or on a single integrated system which performs all the necessary operations. Each of the operations shown in FIGS. 5A-5H optionally correspond to instructions stored in a computer memory or computer readable storage medium of Device 102 or Host 101. The computer readable storage medium optionally includes a magnetic or optical disk storage device, solid state storage devices such as Flash memory, or other non-volatile memory device or devices. In some embodiments, the computer readable instructions stored on the computer readable storage medium are in source code, assembly language code, object code, or other instruction format that is interpreted or executed by one or more processors.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method comprising:
at a processing apparatus having one or more processors and memory storing one or more programs that, when executed by the one or more processors, cause the respective processing apparatus to perform the method:
determining an estimated direction of motion of an entity physically associated with a device that has a plurality of sensors used to generate an estimate of a navigational state of the device based on sensor measurements from one or more of the plurality of sensors, wherein the estimated direction of motion of the entity is based at least in part on:
a device-to-frame orientation, wherein the device-to-frame orientation corresponds to an orientation of the device relative to a predefined inertial frame of reference; and
an estimated device-to-entity orientation, wherein the device-to-entity orientation corresponds to an orientation of the device relative to a direction of motion of the entity;
detecting a change in the device-to-frame orientation; and
in response to detecting the change in the device-to-frame orientation:
dividing the change in the device-to-frame orientation between a change in the estimated direction of motion of the entity and a change in the estimated device-to-entity orientation; and
updating the estimated direction of motion of the entity based on the division of the change in the device-to-frame orientation between the change in the estimated direction of motion of the entity and the change in the estimated device-to-entity orientation.

2. The method of claim 1, wherein the entity is a user of the device.

3. The method of claim 1, further comprising, prior to determining the estimated direction of motion of the entity, determining an initial estimate of the device-to-frame orientation.

4. The method of claim 1, further comprising, prior to determining the estimated direction of motion of the entity, determining an initial estimate of the device-to-entity orientation.

5. The method of claim 4, wherein:
the initial estimate of the device-to-entity orientation is determined based on a change in sensor measurements over time for one or more of the plurality of sensors; and
the sensor measurements used to determine the initial estimate of the device-to-entity orientation include one or more sensor measurements corresponding to a point in time when the device is at rest.

6. The method of claim 1, wherein:
the method includes determining a change in velocity of the device relative to the inertial frame of reference; and
the division of the change in the device-to-frame orientation between the change in the estimated direction of motion of the entity and the change in the estimated device-to-entity orientation is determined based at least in part on the change in velocity of the device relative to the inertial frame of reference.

7. The method of claim 1, wherein:
the method includes determining a magnitude of a radius of rotation of the change in the device-to-frame orientation; and
the division of the change in the device-to-frame orientation between the change in the estimated direction of motion of the entity and the change in the estimated device-to-entity orientation is determined based at least in part on the magnitude of the radius of rotation of the change in the device-to-frame orientation.

8. The method of claim 7, wherein the dividing includes:
in accordance with a determination that the radius of rotation is above an entity-rotation threshold, assigning all of the change in device-to-frame orientation to change in the estimated direction of motion of the entity; and
in accordance with a determination that the radius of rotation is below a device-rotation threshold, assigning all of the change in device-to-frame orientation to change in the estimated device-to-entity orientation.

9. The method of claim 7, wherein the radius of rotation is determined based on a comparison between a measurement of angular acceleration and a measurement of linear acceleration.

10. The method of claim 7, wherein, when the motion of the entity is constrained to motion along a two-dimensional surface, the radius of rotation of the change in device-to-frame orientation corresponds to rotation about an axis perpendicular to the two-dimensional surface.

11. The method of claim 1, wherein the dividing includes:
assigning a first non-zero portion of the change in device-to-frame orientation to change in the estimated direction of motion of the entity; and
assigning a second non-zero portion of the change in device-to-frame orientation to change in the estimated device-to-entity orientation.

12. The method of claim 11, wherein:
the first non-zero portion of the change in device-to-frame orientation includes rotation of the device about a z-axis of the inertial frame of reference; and
the second non-zero portion of the change in device-to-frame orientation includes rotation of the device about an x-axis of the inertial frame of reference.

13. The method of claim 1, wherein:
dividing the change in device-to-frame orientation includes selecting a portion of the change in device-to-frame orientation to assign to the change in the estimated direction of motion of the entity; and
the estimated direction of motion of the entity is updated based at least in part on:
an extent of the change in device-to-frame orientation; and
the portion of the change in device-to-frame orientation assigned to the change in the estimated direction of motion of the entity.

14. The method of claim 1, wherein:
dividing the change in device-to-frame orientation includes selecting a portion of the change in device-to-frame orientation to assign to the change in the estimated device-to-entity orientation; and
the estimated direction of motion of the entity is updated based at least in part on:
an extent of the change in device-to-frame orientation; and
the portion of the change in device-to-frame orientation assigned to the change in the estimated device-to-entity orientation.

15. The method of claim 1, further comprising:
detecting a change in the device-to-frame orientation in each of a sequence of epochs; and
for each respective epoch in the sequence of epochs, in response to detecting the change in the device-to-frame orientation during the respective epoch assigning the change in the device-to-frame orientation to one of the estimated direction of motion of the entity and the estimated device-to-entity orientation to produce an updated direction of motion of the entity or an updated device-to-entity orientation.

16. The method of claim 1, wherein the entity is physically associated with the device when at least one of the following conditions occurs: the device is physically coupled to the entity, the device is coupled to the entity via a flexible connector that constrains motion of the device to an area proximate to the entity, the device is in a container that is physically coupled to the entity, and the device is held by the entity.

17. The method of claim 1, further comprising:
determining a respective type of physical association between the device and the entity; and
identifying one or more constraints corresponding to the respective type of physical association;
wherein dividing the change in the device-to-frame orientation is based at least in part on the one or more constraints corresponding to the respective type of physical association.

18. The method of claim 1, further comprising:
in accordance with a determination that the direction of motion of the entity is constrained in accordance with a mode of transport of the entity,
basing the division of the change in the device-to-frame orientation between the change in the estimated direction of motion of the entity and the change in the estimated device-to-entity orientation at least in part on constraints associated with the mode of transport of the entity.

19. The method of claim 1, wherein:
the entity is physically associated with a first device and a second device;
the method includes determining a device-to-frame orientation of the first device and a device-to-frame orientation of the second device;
the division of the change in a device-to-frame orientation is a division of a change in a device-to-frame orientation of the first device between the change in the estimated direction of motion of the entity and the change in the estimated device-to-entity orientation of the first device; and
the division of the change in a device-to-frame orientation of the first device is based at least in part on a comparison between the change in device-to-frame orientation of the first device and a change in device-to-frame orientation of the second device.

20. The method of claim 1, further comprising:
receiving external information corresponding to a direction of motion of the entity; and
determining the estimated device-to-entity orientation of the device based on:
the external information; and
the device-to-frame orientation.

21. The method of claim 1, further comprising:
detecting a translational shift in a direction of motion of the device from a first direction to a second direction in accordance with translational-shift criteria; and
in response to detecting the translational shift in the direction of motion of the entity:
determining an angular difference between the first direction and the second direction; and
adjusting the estimated direction of motion of the entity and the estimated device-to-entity orientation in accordance with the angular difference.

22. The method of claim 21, wherein:
the estimated direction of motion of the entity is adjusted in a first direction; and
the estimated device-to-entity orientation is adjusted in a second direction that is opposite to the first direction.

23. The method of claim 1, further comprising estimating a location of the entity based on:
an initial location estimate for the entity at a first time;
the estimated direction of motion of the entity between the first time and a second time;
a first estimated stride length of the entity; and
an estimated number of strides of the entity detected between the first time and the second time.

24. The method of claim 23 including after estimating the location of the entity:
detecting a change in a pattern of movement of the device based on integrated measurements from a set of one or more sensors that measure changes in motion of the device over time; in response to detecting the change in the pattern of movement, adjusting an estimated stride length of the entity to a second estimated stride length in accordance with the change in the pattern of movement of the device; and
after adjusting the estimated stride length of the entity, estimating a location of the entity based on:
an initial location estimate for the entity at a third time;
the estimated direction of motion of the entity between the third time and a fourth time;
the second estimated stride length of the entity; and
an estimated number of strides of the entity detected between the third time and the fourth time.

25. The method of claim 1, wherein the change in orientation of the device is determined based on sensor measurements from a set of self-contained sensors.

26. The method of claim 25, wherein the set of self-contained sensors includes one or more of: a gyroscope, a multi-dimensional accelerometer, and a multi-dimensional magnetometer.

27. The method of claim 1, wherein the change in orientation of the device is determined without reference to external signals from predefined artificial sources.

28. A computer system, comprising:
one or more processors;
memory; and
one or more programs, wherein the one or more programs are stored in the memory and configured to be executed by the one or more processors, the one or more programs including instructions for:
determining an estimated direction of motion of an entity physically associated with a device that has a plurality of sensors used to generate an estimate of a navigational state of the device based on sensor measurements from one or more of the plurality of sensors, wherein the estimated direction of motion of the entity is based at least in part on:
a device-to-frame orientation, wherein the device-to-frame orientation corresponds to an orientation of the device relative to a predefined inertial frame of reference; and
an estimated device-to-entity orientation, wherein the device-to-entity orientation corresponds to an orientation of the device relative to a direction of motion of the entity;
detecting a change in the device-to-frame orientation; and
in response to detecting the change in the device-to-frame orientation:
dividing the change in the device-to-frame orientation between a change in the estimated direction of motion of the entity and a change in the estimated device-to-entity orientation; and
updating the estimated direction of motion of the entity based on the division of the change in the device-to-frame orientation between the change in the estimated direction of motion of the entity and the change in the estimated device-to-entity orientation.

29. (canceled)

30. A non-transitory computer readable storage medium storing one or more programs, the one or more programs comprising instructions, which when executed by a computer system with one or more processors, cause the computer system to:
determine an estimated direction of motion of an entity physically associated with a device that has a plurality of sensors used to generate an estimate of a navigational state of the device based on sensor measurements from one or more of the plurality of sensors, wherein the estimated direction of motion of the entity is based at least in part on:
a device-to-frame orientation, wherein the device-to-frame orientation corresponds to an orientation of the device relative to a predefined inertial frame of reference; and
an estimated device-to-entity orientation, wherein the device-to-entity orientation corresponds to an orientation of the device relative to a direction of motion of the entity;
detect a change in the device-to-frame orientation; and
in response to detecting the change in the device-to-frame orientation:
divide the change in the device-to-frame orientation between a change in the estimated direction of motion of the entity and a change in the estimated device-to-entity orientation; and
update the estimated direction of motion of the entity based on the division of the change in the device-to-frame orientation between the change in the estimated direction of motion of the entity and the change in the estimated device-to-entity orientation.

31. (canceled)
